(19) United States
(12) Patent Application Publication
(10) Pub. No.: US 2024/0212407 A1
(43) Pub. Date: Jun. 27, 2024

(54) COMMUNICATION SYSTEM FOR A WEARABLE INTERACTIVE ID BADGE

(71) Applicant: Palarum LLC, Lebanon, OH (US)

(72) Inventors: Patrick Baker, Lebanon, OH (US); Glenn Wolfe, Dayton, OH (US); Chris Baker, Lebanon, OH (US); Marc Roderick, Lebanon, OH (US); Brian Riesenberg, Lebanon, OH (US); Mike Gilkinson, Lebanon, OH (US)

(73) Assignee: Palarum LLC, Lebanon, OH (US)

(21) Appl. No.: 18/291,345

(22) PCT Filed: Aug. 8, 2022
(86) PCT No.: PCT/US2022/039707

§ 371 Date: Jan. 23, 2024

Related U.S. Application Data
(60) Provisional application No. 63/230,855, filed on Aug. 9, 2021.

(51) Int. Cl. G07C 9/28; G08B 21/02

(52) U.S. Cl. CPC G07C 9/28; G08B 21/0269

(57) ABSTRACT

A communication system usable with an interactive wearable badge that is operable to provide security and access control, location tracking, photo identification, and communication of alerts or other useful information in a small package. The disclosed. badge and communication system is optionally useful in caring for patients as part of a patient monitoring system useful for administering patient care in a medical facility or in an emergency response, and/or lor reporting and martialing resources to handle fires, floods, intruders, or other potentially dangerous situations in a facility or other predefined area.

### REFERENCE TO RELATED APPLICATION

The present application claims the benefit of United States Provisional Patent Application No. 62/230,855, filed Aug. 9, 2021 which is hereby incorporated by reference.

### BACKGROUND

Papers, cards, photographs, and many other devices have been used to provide credentials for verifying an individual's identity. With the miniaturization of electronic devices has come a continuous effort to enhance these devices with more and more capabilities.

As demand for additional features and identification methods has grown, the devices themselves have sometimes become bulky, power-hungry, prone to being disabled or hacked, or simply overly complicated for the task at hand, such as in the case of a smart phone or laptop computer. Multipurpose computers can provide additional credentialing capabilities, but they can be difficult to secure, are often outside the control of the organization issuing the credentials, and have a multitude of additional features that put unnecessary demands on battery life. For example, it may be desirable for an electronic identification device to display a picture of the user at all times. In most cases, a smart phone is not equipped with a battery that has enough storage to keep the screen on at all times throughout an eight or 10 hour work day.

Simple devices, such as a key fob, may provide access control and identification capabilities with very low power consumption that is secure and fits in a small package size. However, such devices often lack a screen for displaying photographic identification, and are otherwise often quite limited in their capabilities for user interaction. For example, the small size may limit the types of input the device may accept from the user, if any.

Moreover, as facilities have become more and more integrated with security, building management, emergency response, and other systems, it is increasingly advantageous to have small, lightweight, long-lived, multipurpose ID badges that are interactive and can provide notification of emergencies or important events, that can indicate the location of individuals or resources, and that provide an interface whereby users can respond directly rather than requiring access to a smart phone, laptop, call box, radio, or other device.

### SUMMARY

Disclosed is a communication and alert system for an interactive ID badge. The disclosed system optionally includes badges operable to communicate with other devices such as other servers, tablets, smart phones, or other computing devices, access control or security systems, location finding services, satellites or cellular networks for communication or location finding, location specific beacon(s), and the like, via wired or wireless communication links.

Optional local computer(s) may be included which may accept input or provide output in collaboration with the badge. These local computers may include tablets, desktop computers, smart phones, laptop computers, or any other suitable computing device. In another aspect, events captured by the local computer(s) optionally cause a change to the state of a badge, or multiple badges, and input optionally captured using the badge may cause a change to the state of one or more collaborating device(s). These interactions are managed by the disclosed management system which is operable to facilitate communication between devices and platforms so that personnel may be kept abreast of important events in real time and may be mobilized to respond as needed.

In another aspect, the disclosed management system is optionally configured to coordinate with access control/security systems which may be configured to confirm credentials of a badge user. The management system of the present disclosure may be configured to query the servers or other computers of the access control system when a badge is assigned to a user. In another aspect, the management system may be optionally configured to update the access control system with new credentials provided by the user, and/or with an indication that a badge has been assigned to a particular user, optionally including information about which specific badges were assigned to individual users.

In another aspect, the disclosed interactive badge my collaborate with patient care systems to receive notifications or alerts, and to optionally coordinate a response amongst one or more badge users. Such systems may include systems for monitoring patient activity in a hospital, clinic, nursing home, or other facility where a patient may be receiving care. More specifically, a monitoring system may interact with the disclosed communication system to detect patient activity and to analyze this data in real time to predict when a patient is likely to stand, which may lead to a fall, for example, from a bed, chair, or other supporting structure. When the system determines that a fall is imminent, nearby caregivers may be alerted via the disclosed badges, or other nearby computers, and can then offer timely assistance thus increasing the chance of avoiding a fall before it happens.

Further forms, objects, features, aspects, benefits, advantages, and examples of the present disclosure will become apparent from a detailed description and drawings provided herewith.

### BRIEF DESCRIPTION OF THE DRAWINGS

FIG. 1 is a component diagram illustrating components that may be included in a communication system of the present disclosure.

FIG. 2 illustrates an example of escalation zones for the communication system of the present disclosure.

FIG. 3 illustrates an example of the communication system of the present disclosure installed in a facility.

FIG. 4 illustrates another example of the communication system of the present disclosure installed in a facility.

FIG. 5 illustrates other aspects of the communication system of the present disclosure installed in a facility.

FIG. 6 illustrates another example of the communication system of the present disclosure installed in a facility.

FIG. 7 illustrates another example of the communication system of the present disclosure installed in a facility.

FIG. 8 is a flow diagram illustrating actions that the communication system of the present disclosure may take in associating a user with a badge.

FIG. 9 illustrates an example of the communication system of the present disclosure providing access control to a secure areal.

FIG. 10 illustrates one example of components that may be included in a badge of the present disclosure.

FIG. 11 is a component diagram illustrating components of a patient monitoring system for use with the communication system of the present disclosure.

FIG. 12 is a component diagram illustrating aspects of a patient monitoring device like the patient monitoring device in FIG. 11

FIG. 13 is a component diagram illustrating aspects of a server like the server in FIG. 11.

FIG. 14 is a component diagram illustrating aspects of a data store like the data store in FIG. 11

FIG. 15 is a component diagram illustrating aspects of a computer like the computer in FIG. 1

FIG. 16 is a flow chart illustrating actions that may be performed by a patient monitoring system like the system of FIG. 11

FIG. 17 is a flow chart illustrating actions that may be performed when triggering alerts in a patient monitoring system like the system of FIG. 11

### DETAILED DESCRIPTION

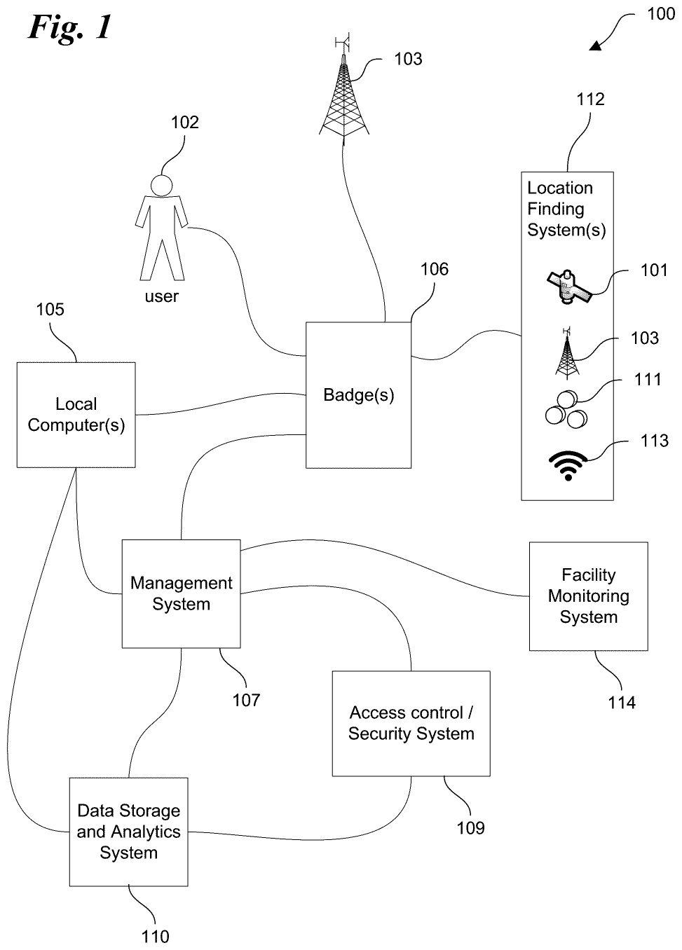

One example of components that may be included in the disclosed communication system is illustrated in FIG. 1 at 100. In one aspect, the management system 107 may include one or more servers, or other computers configured to implement the disclosed functionality. These system management computing devices may be configured or programmed to manage badges 106 and/or badge interaction with the local computers 105, or other services of the present disclosure such as access control/security systems 109, data analytics systems 110, and the like.

A badge 106 of the present disclosure is optionally configured to communicate with the other devices that may be incorporated into the system. Examples include other computing devices 105, management system 107, access control or security systems 109, location finding systems 112, and a facility monitoring system 114. These aspects of the disclosed system may be separate entities, implemented in separate facilities, or on separate servers, or they may be implemented on the same servers in a single facility, or any combination thereof. For example, the management system 107 may include a facility monitoring system 114, access control security system 109, and or data storage analytics system 110. In another example, each of the components illustrated system 100 may be separate and distinct from one another.

In one aspect, the location finding systems 112 may include, but are not limited to satellites 101, cellular networks 103, WiFi networks 113, or other wired or wireless networks 103, and/or beacons 111. Other devices or systems may include satellites 101 or cellular networks 103 either one, or both of which, may be used by the disclosed badge and alert system for communication or location finding. The components illustrated in FIG. 1 may be responsive to one another and may communicate with one another via any suitable combination of wired, wireless, or other communication links. Examples of these communication links are shown as lines connecting the components of FIG. 1. FIG. 1 is illustrative, rather than restrictive, as any suitable arrangement of communications links may be implemented to achieve the features and functionality of the present disclosure.

In another aspect, the local computer, or computers, 105 (which also may be referred to as a collaborating computing devices) may optionally be configured to accept input or provide output according to communications sent or received between one or more badges 106 of the present disclosure and the local computer. The operation of the badge 106 may adjust according to input received from a local computer 105, and the operation of the computing device, or devices, 105 may change according to input received from a badge, or multiple badges, 106. Thus the badges 106 and the local computers 105 may be arranged and configured to be responsive to one another using one or more communication links.

The local computer(s) 105 may include one or more processors configured or programmed to accept input from users 102, provide output to the badges 106 or accept input from them, and similarly provide output or accept input from other devices or systems. These computing device(s) 105 may be include control logic or control circuits implemented to provide aspects of the disclosed functionality. For example, input provided by a user 102 using a computing device 105 may be communicated to the badge 106, either directly as entered, or after the computing device 105 has processed the input to generate output for the badge 106. This output from another computer may be received by the badge 106 and the badge may be configured to change state accordingly based on control logic in the badge.

In another aspect, servers of the management system 107 may include one or more processors configured or programmed to accept input and/or provide output to other components of the disclosed system including, but not limited to, the badges 106, collaborating devices 105, other management system 107, access control or security systems 109, and data storage and analytics systems 110, to name a few nonlimiting examples. Servers 107 may optionally include control logic or control circuits implemented to provide the disclosed functionality.

In one aspect, the management system 107 may be configured or programmed to manage badges 106, and interactions between the badges and other components or systems of the present disclosure. In one example, the management system 107 optionally collects location information from badges 106. The badges 106 may communicate and/or be responsive to location finding systems 112 and may use these systems to determine the location of a badge in a facility, and/or anywhere on the surface of the earth. In another aspect, the location finding services may determine the location of a badge anywhere within a specified geographical area which is optionally defined by management system 107. The badges 106 are optionally configured to use management system 107 which may be optionally configured to triangulate a location of one or more, or all, badges 107 in real time to maintain data about the position of the badges, and thus to maintain a real-time, or near real-time situational awareness of the physical location of the badge(s) 107 (and by extension, the persons or things associated with each badge).

In another aspect, the data and analytics system 110 is optionally configured to accept data from collaborating devices 105, the management system 107, access control/security system 109, badges 106, and/or local computers 105 via the disclosed communication links. The analytics system 110 may be configured to use the data from these other systems for various purposes. These include, but are not limited to, determining improvements that may be made to the control logic of the other components of the system, and/or preparing updates to that control logic incorporating these improvements. These improvements may then be delivered via the disclosed communication links, either directly, or indirectly, by any suitable means such as by a software upgrade administered remotely from the management system 107. In another aspect, the data storage and analytics system 110 may be configured to store and analyze data obtained from badges, local computers, the management system, the access control/security system, or from other aspects of the disclosed system for the purpose of detecting patterns of usage and/or operation of these devices that may be adjusted to improve the operation of the system or of the individual components.

The optional data storage and analytics system of the present disclosure may be configured, programmed, or otherwise operable to accept data from computing devices, badges, or other systems. For example, the disclosed analytics system may be configured to accept badge usage data from a management server, access control system, or other source. In another aspect, the analytics system is optionally configured to accept alert information including, but not limited to: What happened, where it happened, who was notified, how long it took the notified individuals to respond, the badge(s) that responded (and optionally which badges did not respond), and the like. In another aspect, and analytics system of the present disclosure may be configured to automatically generate reports that include alert information, either individually, or in an aggregated form showing trends in response times, number of events, type of events, overall response required to resolve the issues raised by the event, or other information obtained over time.

In another aspect, the badge management system of the present disclosure is optionally configured to receive and manage location data for the badges thus allowing the system to notify the closest badges when an incident occurs. In one example, the location information is optionally obtained by each badge and sent to the management system to allow that system to maintain a location of the badge in real time. Optionally, the location of the badge may be obtained by an interface implemented in hardware or software or any combination thereof and is optionally configured to establish a communications link with geopositioning satellite systems 101 such as the Global Positioning System (GPS), the Global Navigation Satellite System (GLONASS), and the like.

In another aspect, the location finding aspects of the system may interface with a cellular communication interface to establish a communications link with cellular telephone network 103. This cellular communication interface may be implemented in hardware or software, or any combination thereof, and may optionally be configured to update badges and/or management system with location information for each badge. In another aspect, the cellular communications interface may be configured to establish and maintain communication links between a badge and other components of the system such as between servers of the management system, a local computer, the data analytics system, the access control/security system, and the like.

The badges of the present disclosure may also include a user interface by which users may submit information to the management system via the cellular network. Information may be submitted via voice message and, Simple Message Service (SMS) text messaging, live video feeds, still images, or by other means that may be made available by the badge. For example, a badge may be equipped with a camera, microphone, and/or keyboard to facilitate direct communication with other badge holders via cellular communication network, Wi-Fi, or other suitable networking protocols.

In another aspect, the badges of the present disclosure may include a beacon communication interface which may be configured to establish a communications link with one or more beacons 111. This may be a one-way, or two-way communication link. The badges of the present disclosure may determine the strength of the received signal emanating from the beacons, also known as Received Signal Strength Indicator (RSSI). Because the signal strength received by a badge from a beacon decreases with distance, the RSSI can be compared by the badge with a reference signal strength at a fixed point at a given distance from the beacon. From this, the badge may determine approximately how far the badge is from the beacon. The badge is optionally configured to receive multiple signals emanating from multiple beacons that may be positioned in and around the area where the badge is used. Beacon data from one or more beacons may comprise a beacon identifier, and an estimated distance (or the RSSI value itself), and it may be sent to the servers of the management system for processing to determine the location of the badge. In one aspect, the management system servers may maintain a detailed map of the beacons deployed in the area. The management system servers may then use this map and the RSSI data obtained by the badges to triangulate a location for a given badge, preferably separately for all badges.

In another example, the badges of the present disclosure are optionally configured to transmit signals to a collaborating computer (such as a tablet, smart phone, desktop, or other suitable computer). The signals transmitted by the badge may define data which may include an identifier that optionally uniquely identifies an individual badge from all other badges. The badge may establish a communication link directly with the collaborating computer by any suitable means including wired or wireless communication protocols. In one aspect, the signal is sent by a radio transmitter implementing the WiFi, Bluetooth, or optionally the Bluetooth Low Emission (Bluetooth LE) protocol (for reduced power consumption by the badge). Any suitable wired or wireless protocol may be used. In another aspect, the signal is sent by the badge at predetermined intervals such as less than 1/100 of a second, less than 1 second, less than 30 seconds, or 30 seconds or more to give a few non-limiting examples. The badge may be configured to accept input from a user adjusting the predetermined interval.

The signal sent by the badge may be received by the local computer of the present disclosure using the communication link established between the badge and the local computer. In one example, the local computer includes a radio receiver that is configured to operate according to the Wifi, Bluetooth, or Bluetooth LE protocols (or any other suitable protocol). The signal may be received by the local computer, and the local computer may determine the RSSI for the signal, and the unique identifier for the particular badge sending the signal. This information is optionally relayed by the local computer to the servers of the management system.

In another aspect, the management system servers may be configured or programmed with hardware and/or software operable to triangulate or otherwise determine the positions of the badge sending the signal relative to the local computer. In another aspect, the local computer may be mounted within a room or other predetermined space, and the precise location of the local computer with respect to other rooms, walls, doorways, hallways, stairs, elevators, or other landmarks within a building or facility may be maintained by the management system computers. This location may be used in determining the precise location of the badges in the area by evaluating the distance from several nearby local computers for each badge in the area.

In another example, the management system 107 may be configured or otherwise operable to send information defining how the badge(s) should respond that includes an alert level, and possible other alert specific information. A badge of present disclosure may be programmed or configured with control logic for managing alerts which may be configured to specify different responses for different alert levels. In this example, the management system of the present disclosure may notify the badge (such as badge 106, and others disclosed herein) that an alert has been raised, and it may then be left to the control logic internal to the badge to determine the appropriate response. The badges may be programmed or otherwise configured with logic differentiating how each different badge should respond, and this response may vary according to the distance from the event, the person associated with the badge and their roles, responsibilities, level of experience, and the like.

A “response” to an event may be defined in different ways by the management system. A “response” may be defined by the system according to rules specifying criteria for when a “response” is considered to have occurred. In one example, the rule criteria may require an individual wearing the badge to move within a predetermined threshold distance of the event location specified in the event. The management system may automatically determine that an individual badge wearer has responded and thus may alter the state of the badge, enter a record of response into the activity log maintained by the management system, alert other individuals of the response, or any combination of this or other actions. Thus moving to within a predetermined distance of an event may be considered a “response.”

In another aspect, the rule criteria may require that no response is recorded unless a specific action is taken. For example, in a hospital setting, if the condition of a patient should deteriorate below a predetermined level, the medical equipment in the patient's room, at the nurse's station, or elsewhere, may initiate an alert, and the management system may broadcast that alert. The management system may include criteria specifying that the alert has not been responded to until the settings of the medical equipment have been adjusted in some way. For example, the alert may not be satisfied until the medical equipment detects a change in the settings of the equipment increasing the flow of oxygen to the patient in response to a low blood oxygen level alert.

In another aspect, the management system may define response criteria to require multiple individuals to respond to different locations that are not at the site of the event that generated the alert. Thus the alert may be caused by an event at a first location, while the criteria for an adequate response may require a resource to move to a second different area that is remote from the first location. For example, an alert may be generated by a sensor detecting heat or smoke in a building. The sensor may, for example, be part of a building management system, or security system. An alert may be raised automatically that has criteria requiring that a fire brigade respond to the location, while also requiring that members of the maintenance staff assemble at one or more other locations so as to be ready to provide other services such as cutting electricity to a portion of the building, increasing the flow of water, cutting off gas to the building, activating a generator, vector newly arriving emergency services to the scene, examining access logs to determine who is in the building, and the like.

In another example, software configured to monitor a file system, a fire wall, a server, a network, and the like, may initiate an alert upon the detection of suspicious activity occurring on a computer network or on individual computers coupled to the network. The criteria associated with this alert may require alerting one person physically closet to the device that raised the alert condition, and may optionally require sending an alert to multiple members of a cyber security team stationed at locations in the same facility, in a different 15 building across town, or at locations around the world. A “response” may be automatically registered by the management system when the members of the cyber security team log into the system, or when one or more diagnostic or remedial actions are taken, and the like. These are several nonexclusive examples of how different activities can be initiated by a single alert with multiple response criteria. If some or all of the criteria are not satisfied, which is to say one or more individuals fail to take the prescribed actions, the system may then initiate an escalation procedure to bring more resources to bear where they are needed.

In one aspect, the criteria defined by the management system may specify a response is considered inadequate if no badges respond, or if alert condition are not “cleared” by a responder wearing a badge before a predetermined period of time has passed (“a timeout period”), or if an insufficient number of individuals wearing badges respond. In that situation, three of 10 notified individuals may arrive near to the event cite, or may “clear” the alert by providing input via their individual badges. Such input may come via pressing a button on the badge, touching an icon displayed on the badge's display device, or in any other suitable manner. The system management server may be programmed to note that the number of badges responding is less than the number notified according to the escalation plan, and this deficiency may then automatically trigger an escalation action whereby the management system automatically notifies more resources to respond by sending an alert to their badges.

In another aspect, management system 107 may include one or more computers of any suitable type which are optionally configured to define, and/or accept input defining, multiple response zones, or “zones” for short. A zone generally refers to a predetermined location, region, or area (a physical definition) or to a predetermined group of roles or responsibilities or individuals assigned to respond to alerts according to the circumstances (a functional definition). In one example, a zone may be defined as the closest badges. For example, an initial zone may include the closest three badges, the closest five badges, the closest 25 badges, or any other suitable number. In another aspect, a zone may be defined to include any badges presently on a specific floor of a building, a group of floors in a building, the entirety of, or a portion of, multiple separate buildings, and the like. A zone may be defined to include multiple buildings or facilities across town, or around the world

In another aspect, a subsequent or next level zone may be defined as the next closest group of badges (the next closest five badges, the next closest 10 badges, and so on). These subsequent badges may, or may not include, badges in the initial zone. In another aspect, a zone may include the closest three badges associated to members of a particular team, or with particular roles and responsibilities.

In another aspect, a zone may be defined to include safety and/or security personnel assigned to an area, or assigned to respond in general. A zone may be defined to include other resources such as fire department, sanitation, hazardous materials response teams, first responders, emergency medical technicians, technical support, or other resources that may not be located in the same building, facility, or campus. For example, a zone may specify the closest five badges associated with individuals having a specific skill set, specific training, or access to resources or tools that may be helpful in addressing the alert. A zone may specify notifying the closest five badges associated with nurses, or the nearest member of the janitorial staff, or the nearest three fire stations that are closest to a particular building or other location, or an armed member of the security staff versus an unarmed member, members of the information technology staff, any five members of a cybersecurity team which may be located in different places around the world, or an administrator or group of administrators, and the like.

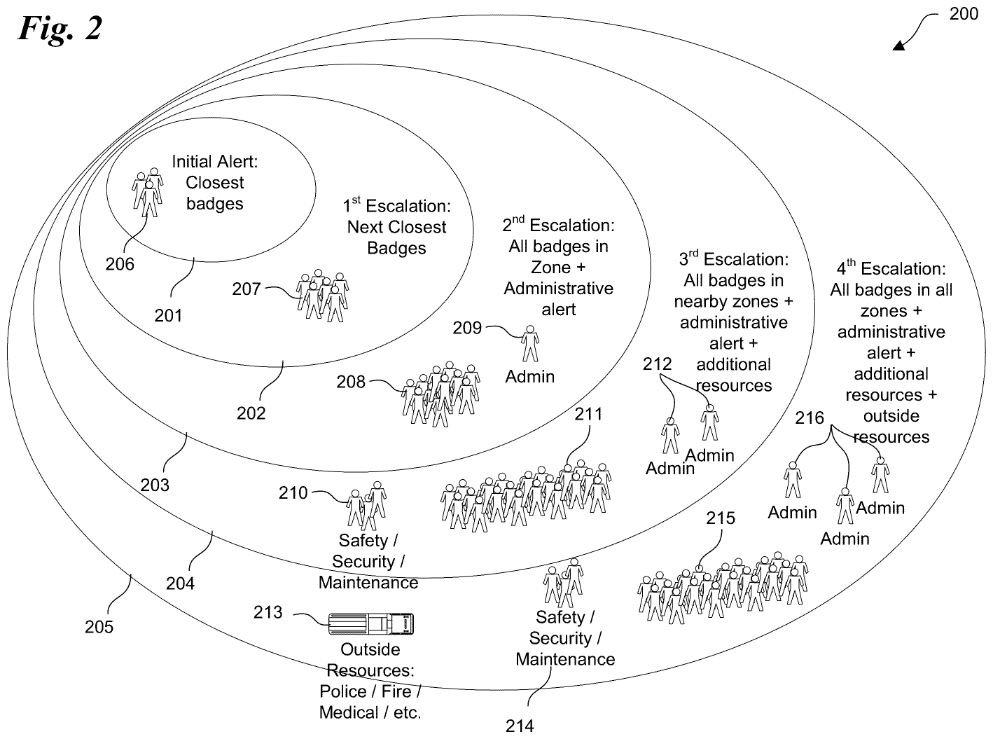

One example of an escalation plan is illustrated in FIG. 2 at 200. As discussed previously, badges are generally associated with individuals, and these individuals may be organized by the management system into zones, either physically by a location relative to the incident that caused the alert, or functionally according to a roles, responsibilities, and/or skills. FIG. 2 is illustrative rather than restrictive, and is merely one example of how an escalation process might be organized. The disclosed management system may be configured to automatically activate more badges thus requesting additional resources from the same zone or from other zones to bring additional resources to bear as the incident that caused the alert escalates, or in the case where badges that have already been notified have not responded.

In one aspect, the system may require one badge for initial response, three or more for next level, five or more for the next level, etc. As the escalation level increases, the number of badges required to respond my also increase. As illustrated in FIG. 2, a management system of the present disclosure may be configured with control logic that is programmed or otherwise configured to notify a first zone 201 when the initial condition occurs that causes the alert. This Is zone may include an initial group of the closest badges 206, or if not physically the closest, those badges that are most closely associated with the resources needed to address the situation. The management system may be configured to automatically determine the location of the closest single badge, closest three badges, closest five badges, etc., or a mix of the closest badges with particular skill and/or the badges that are physically the closest in order to mount an adequate response.

If the management system determines that the initial response is inadequate, the system optionally escalates to a next response level (which may also be thought of as a “first level escalation”) 202, which is optionally part of a predetermined escalation plan. The escalation plan optionally includes rules with criteria configured to take into consideration the badges that have already been notified, the ones that have responded, the location and type of the incident, and any other relevant information in determining the next step in the escalation plan. This plan may include notifying an additional number of badges, such as an additional closest three badges 205, or an additional closest five badges, or more (or less) as criteria in the escalation plan may dictate. Criteria in the escalation plan may be configured to notify badges 207 in addition to badges 206, or in place of them, or any combination thereof. For example, the criteria may be configured to send a “stand down” message to badges 206 when the system sends the initial alert message to badges 207. In another example, badges 207 may be sent the alert which may be the same, or similar to, the alert sent to badges 206, without sending any “stand down” message to any existing badges that have been alerted, and/or have responded to the crisis situation. Thus, the escalation plan may be configured to bring additional resources to bear, or to replace the current resources with other resources with perhaps more skills, system access, equipment, or other capabilities, and the like.

If the response to this initial escalation is inadequate, the management system optionally moves to a 2^{nd} level escalation notifying an additional group of badges 208 specified in another zone 203. This additional group of badges 208 may be notified in addition to the initial badges notified 206, or badges 208 may be notified in place of badges 206, or any combination thereof to meet the present need, as discussed above with respect to the 1^{st} level escalation. In this example, this 2^{nd} level escalation 203 may include an administrative alert sent by the management system to a badge associated with an administrative member 209.

If the 2^{nd} level escalation response remains inadequate, the management system optionally includes control logic configured or programmed to send an alert to other badges in a 3^{rd} escalation zone 204. Zone 204 may be defined according to criteria specified in the escalation rules that optionally includes notifying additional (or replacement) members of management 212, and additional group of physically close, or functionally related individuals 211 needed to respond. In another aspect, escalation criteria for zone 204 may include security, safety, medical, or maintenance resources 210.

If the 3^{rd} level escalation response remains inadequate, the management system optionally includes criteria defining a fourth level escalation 205. This escalation level may include criteria specifying additional or replacement safety, security, or maintenance resources 214, additional or replacement badges 215, additional or replacement administrators 216, and/or outside resources such as police, fire, medical, hazardous materials teams, or other resources. In another aspect, the outside resources may be automatically alerted by the management system via a communications link maintained between the management system and these outside resources. For example, a server of the disclosed management system may automatically dial a number and play a prerecorded audio message, send an predetermined automated email message, send an activation signal to a central dispatcher, send SMS messages, notifications, or any other suitable method. Any of these automatic disclosure techniques may include information about the alert such as the location, severity, resources already dispatched, administrator contact information, roles and responsibilities for those individuals already responding, and the like. In another aspect, these outside resources 213 may also have badges assigned to them for this purpose, or they may be equipped with an automated alert device responsive to the management system that may be activated by the system to initiate the escalation procedure. For example, such an automated device may be a transponder or computer in communication with the management system via a communication link, either one or both of which may be located at a dispatch center, at nearby fire, police, or ambulance stations, and the like.

Thus the management server 107 and the badge 106 collaborate in any suitable manner to raise an alert. A portion of the alert control logic may be maintained and executed by the management system, and a separate portion by the badges, or any suitable combination thereof.

In another aspect, the management system 107, or the badges 106, maybe programmed or configured to automatically clear alerts or warnings when a badge passes to within a predetermined threshold distance from a predetermined location or event. This location may be provided by the servers 107 to the badges 106 as part of the alert information. For example, the management system and/or the badges may be configured to clear an alert when a person having a badge gets within two feet, within 10 feet, within 50 feet, or at a distance beyond 50 feet, of the device, location, user, or person, that is related to or caused the alert.

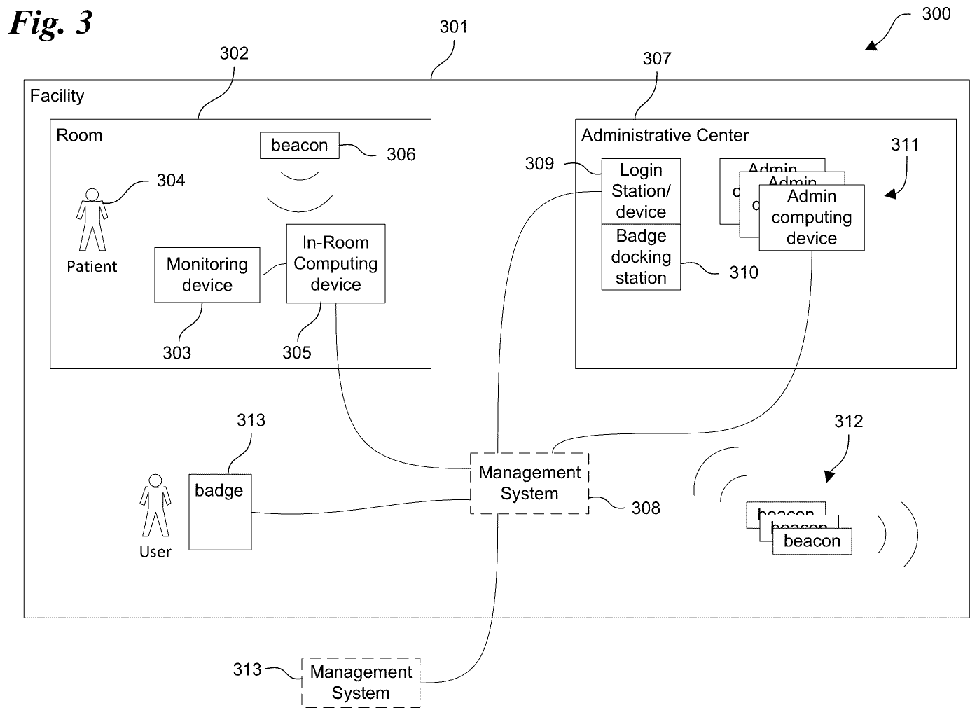

One example of the disclosed system is illustrated in FIG. 3 at 300. A facility 301 may include one or more rooms like room 302. For example, the disclosed badge and management system may be used in a hospital, nursing home, or other medical environment. As discussed throughout the present disclosure, the different rooms and areas of a facility or other area being monitored may be accessible via multiple different access points which may include doors, gates, windows, elevators, or other selectively openable areas. These location, dimensions, and other data about these areas may be stored in the management system servers, such as in the case of electronic map data with meta data about each of the areas optionally associated with the map data. The management system may use this information in determining which badges to send an alert to based on the shortest paths between the badges and the event that triggered the alert.

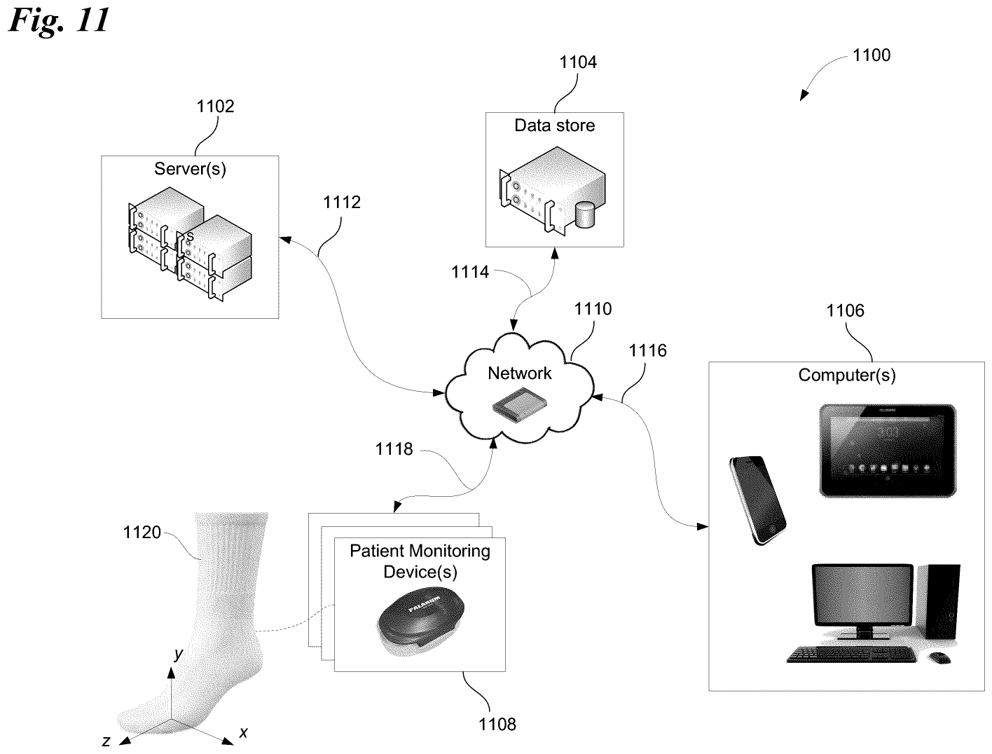

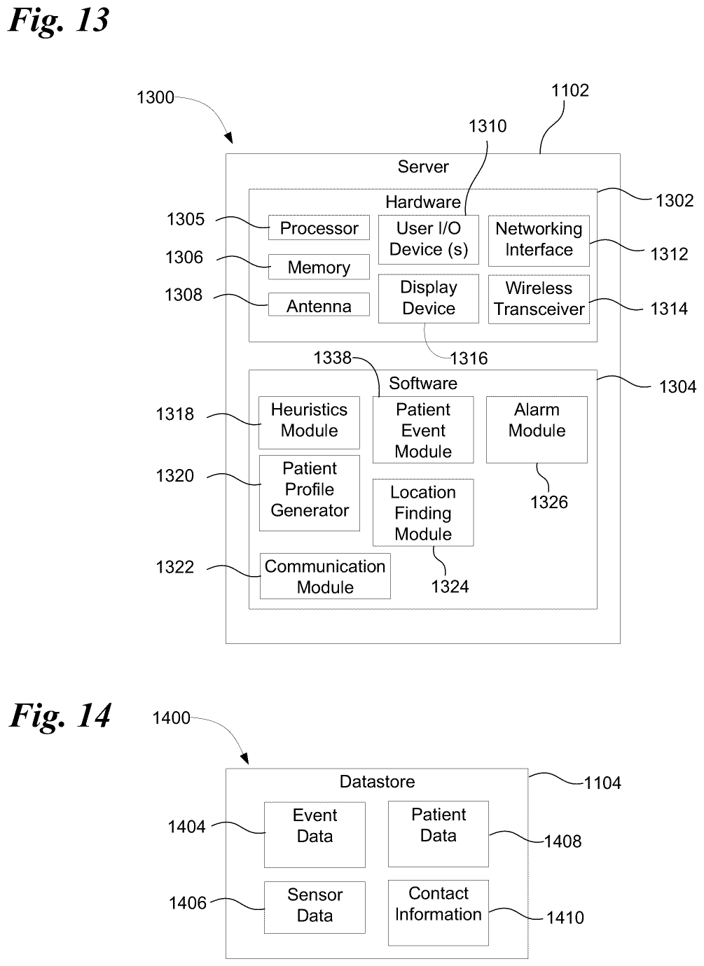

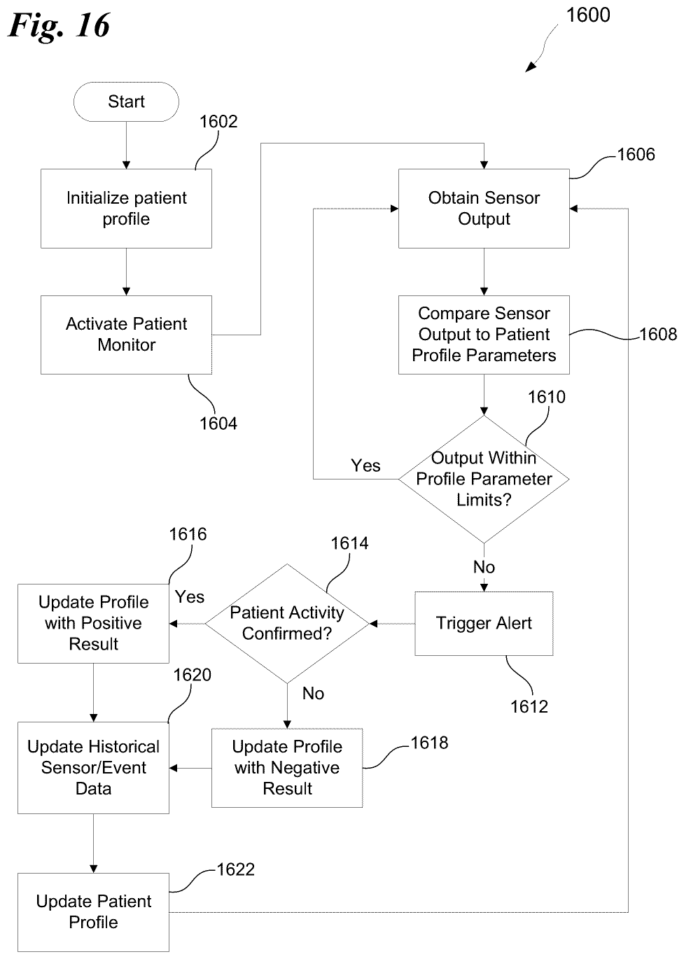

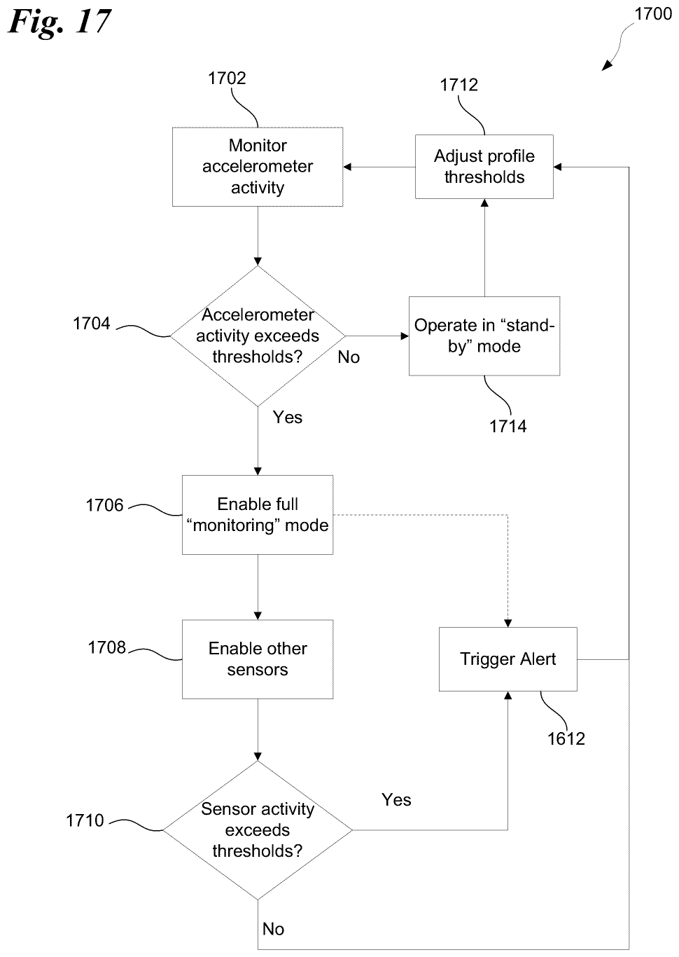

A room may optionally be used by a patient 304 and may optionally be shared by more than one patient. Patient 304 may be associated with a monitoring device 303. In on example, the monitoring device is a wearable device that may be worn by the patient along with, or as part of, a garment such as a sock, shirt, gown, and the like. The monitoring device 303 may communicate with an in-room computing device 305 via any suitable communication link, such as a wired, wireless, and the like. This device 305, and/or the monitoring device 303 may be examples of a local computer 105 illustrated in FIG. 1. One example of a monitoring device that is operable to detect when a patient is about to stand up is illustrated below in FIGS. 11-17.

A beacon 306 is optionally mounted within, or otherwise included in the room 302. The beacon 306 may be one of beacons 111 in FIG. 1, or any other beacon of the present disclosure, or may operate in a similar manner thereto. Other beacons 312 may be positioned in other locations around facility 301 thus providing location information specific to the areas where the beacons may be mounted or otherwise deployed. As disclosed herein, the beacons may interact with the badge, the in room computing device (or other local computing devices) to determine the location of the badges with respect to the patient and the local computers.

Also shown in the example of FIG. 3 is an optional administrative center 307, where one or more administrative computing devices 311 may be located. FIG. 3 illustrates this administrative center as being located in the same facility as the rooms 302, and other aspects of the disclosed system, however, this is only illustrative as the administrative center may be in another facility, in the same facility, or in a remote location. Examples of an administrative center include, but are not limited to, a nurse's station, an office, an administrator's desk or station, a kiosk in a factory or warehouse, a guard house or guard station such as might be near an entrance or exit to a facility, a mobile command vehicle, a maintenance vehicle, and the like.

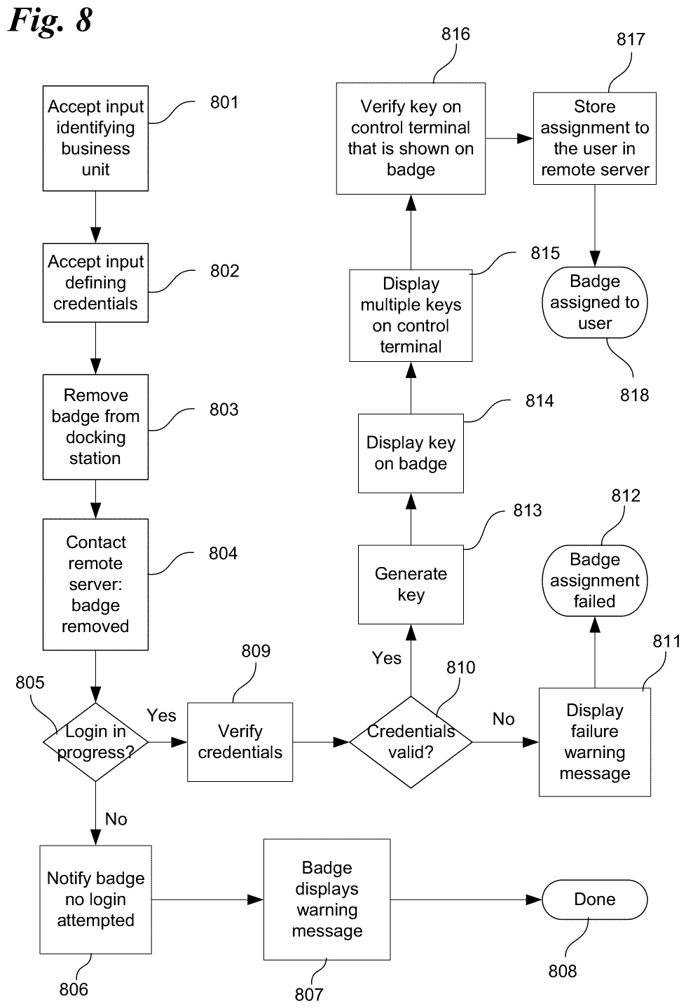

The administrative center 307 may also include a login station 309 that may be configured to assign or associate a badge 313 to an individual user according to any suitable procedure, one example of which is illustrated herein in FIG. 8. In another aspect, the administrative center 307 may include a badge docking station 310 arranged and configured to accept one or more badges 313 for storage, installation of software upgrades, maintenance, and/or to optionally charge an internal battery of the badge. As described in further detail herein, a user may obtain an unassigned badge 313 from the docking station 310, and use the badge in conjunction with the login station 309 to activate the badge, and/or associate it with the user who is logging in. This process might be performed any time, but one example would be when a person enters the facility to begin work for the day, for a shift, or for any other suitable period of time.

The badge docking station 310 optionally includes a stationary mount with one or more terminals contacting corresponding terminals of the badge. In another example, a badge docking station optionally includes a stationary mount with a wireless charging coil that passes a charge to a battery in the badge via a corresponding wireless charging coil positioned in the badge

In another aspect, the management system of the present disclosure may optionally be configured to notify one or more badges of the present disclosure of an alert generated by the management system. These alerts, discussed throughout the present disclosure, may include a payload optionally comprising data, commands, information streams, files, or other aspects of the alert such as the severity, the person or system that is associated with the alert and/or caused the alert to be generated, the date and time the alert was generated, escalation information, count-down timers or other reminders for the person assigned to respond, and the like.

In one example, the alerts may include information defining how a badge of the present disclosure should respond to the alert. In this way the management system of the present disclosure may control the badges according to a predetermined response plan programmed in the software and/or hardware of the management system computers. In one example, triggering information sent by the management system may specify that the badge is to respond to the alert by activating an audible alarm, a visual alarm, or by changing an image on a screen of the badge, and the like, or any combination thereof.

The badge may be configured to optionally provide hot to cold to realize well is really: Aaron I have a lot of die goals and make it try information such as patient fall risk information, patient biometric information and/or patient location information. The badge may be configured to provide the location of other staff, a staff alert message, patient name, and/or a photo of the person associated with the badge and their occupation information, or any combination thereof. The badge may be configured to display alert text information, and to provide an input device that is configured to accept input from the user that sends an alert message to nearby staff members and/or to the management system. In another aspect, triggering an alert message optionally includes triggering an audible, visual, tactile, haptic, or other alert using the badge.

In another aspect, the management system of the present disclosure may include control logic specifying actions, or groups of actions, that badges worn by specific users, or groups of users should take. For example, in some situations, the management system may specify that an audible alarm is required for badges associated with a “first response”, which may be defined as the badges worn by individuals who are physically close to the triggering event or person and should take immediate action. In another aspect, a flashing lamp of the badge (with or without an audible alarm) may be activated at about the same time for badges associated with individuals who are more senior in an organizational chart to those in the “first response” category. Any suitable arrangement of coordinated response may be orchestrated by the management system, other examples of which are disclosed herein elsewhere.

In another aspect, the servers of the management system may be in the same facility or outside the facility. For example, as illustrated in FIG. 3, the management system may have a local component that is located in the facility, or on the same campus with other facilities which are also managed by the management system. In another aspect, the management system may include a remote aspect 313 which may be located offsite in another location nearby, across town, on the other side of the world, or anywhere in between.

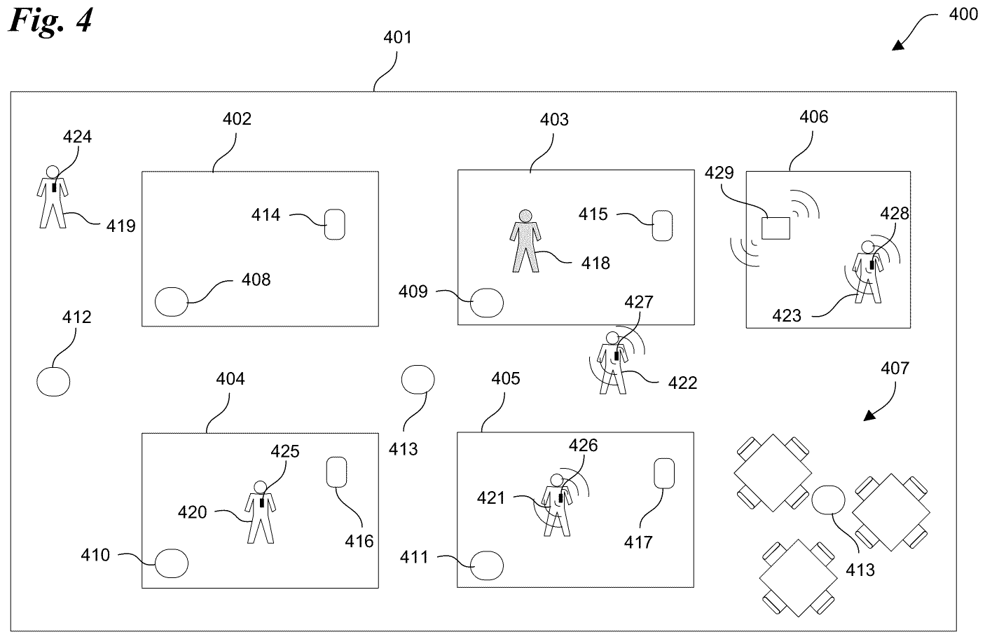

FIG. 4 at 400 illustrates one example of a system of the present disclosure initiating an alert. In this example, a facility 401 optionally includes multiple rooms 402-405, an administrative area 406, a common area 407, multiple beacons 408-413, one or more in-room computers 414-417, or any combination thereof. One or more monitored individuals 418 such as patients in a hospital, workers in a warehouse, inmates in a prison, students in a school, and the like, may be present in the facility. Individuals 419-423 may be present in the facility and each may be carrying (or otherwise using associated with) an individual badge of the present disclosure 424-428.

In one aspect, a patient 418 may initiate an alert such as by attempting to stand up, or because of an adverse physical condition such as by experiencing high or low blood pressure, heart rate, respirations, or other physical symptoms that are above/below predetermined threshold limits. The servers of the management system may optionally determine that the closest three badges should respond, and thus badges 426, 427, and 428 may be determined as the closest. This determination of which badges are closest may be made in any suitable manner, examples of which are offered herein elsewhere. The location of each badge is optionally determined in accordance with the present disclosure by optionally utilizing beacons 408-413, in room computers 414-417, or any combination thereof. Depending on the incident and the criteria associated therewith, the management system may activate the closest badge, closest two badges, closest three badges, or more, possibly activating all available badges no matter how close or far away they may be from the incident. This full activation may occur initially when the alert is triggered, or in a staged manner as discussed herein with respect to an escalation procedure.

In this example, the closest three badges 426-428 are optionally notified resulting in these badges buzzing, flashing, vibrating, etc. according to the various alert notification methods of the present disclosure. In this example, badges 424 and 425 are not initially alerted because they are farther away from the individual 418 that caused the alert. In another aspect of this example, all resources are optionally on the same floor of facility 401. In another aspect, all resources may be defined as being part of the same zone defined either as a physical space (e.g. a floor of a building), or as part of a group of individuals having specific skill sets, responsibilities and the like (e.g. all are nurses or doctors on the same floor, or optionally all nurses or doctors without reference to where they might be at the time). As discussed herein, the management system may escalate by activating more badges as discussed herein if the initial response by individuals 421-423 is inadequate.

In another aspect, an alert device 429 is optionally included which may be a centrally located device configured to notify anyone nearby that an alert has been initiated. Alert device 429 may be a centrally located computer screen that includes a flashing icon or other graphical display shown on a display device indicating an alert is in progress. In another aspect, alert device 429 may include an audible alarm buzzer, and/or a visible flashing lamp or strobe. In another aspect, the alert device may include a wall mounted lamp that changes from green to blue, or green to red, or flashes, etc. indicating a “code” level for the alert that is visible even to those nearby individuals who are not wearing a badge or whose badges has not been activated.

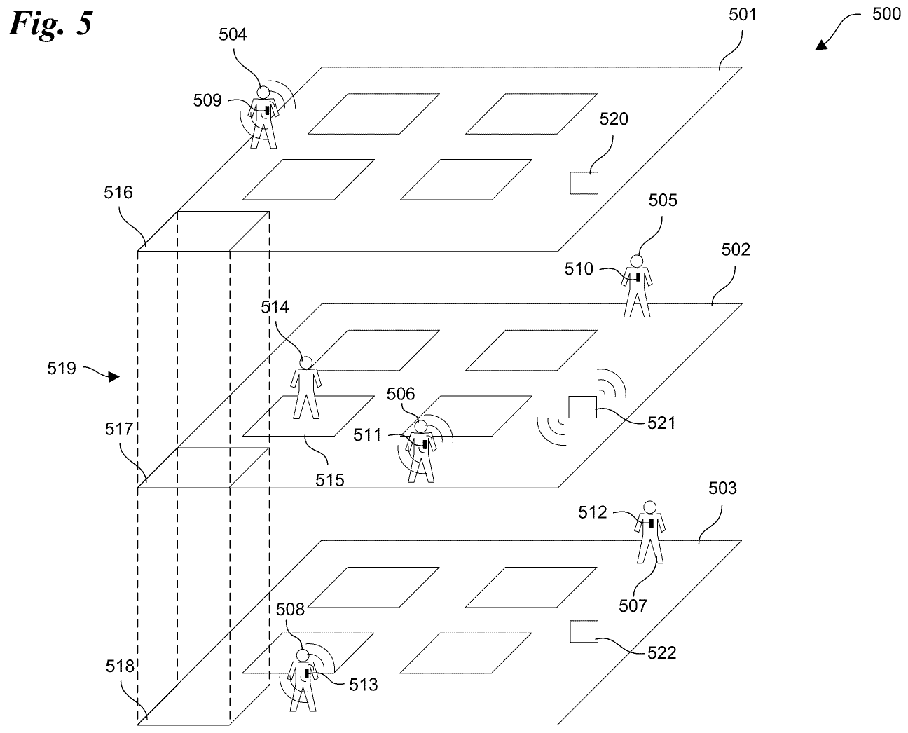

FIG. 5 illustrates at 500 other aspects of the communication and management system of the present disclosure. A zone of the present disclosure may be defined as including multiple floors 501-503 of a building, and the management system may accordingly be operable via software and/or hardware to determine the shortest distance to the scene of an alert occurring in a room 506 while taking into consideration the vertical layout of the space as well. For example, exits 516-518 may be positioned on floors 501-503 respectively, and together these exits may comprise a stairwell, elevator, or other vertically aligned exit 519. In another aspect, the management system of the present disclosure may maintain a three-dimensional model of the physical area of interest in order to determine which badges to send an alert to. Badge alert determinations may optionally take into consideration the individuals on floors above or below the area where the activation occurred.

For example a patient 514 in room 515 of the 2^{nd} floor 502 may cause an alert to be initiated. The management system servers optionally take into consideration the distance to the patient 514 in room 515 by considering multi-floor access via exit 519, and the time required to move between floors. Here, the management system tracks the position of individuals 504-508 as they move about the three floors. Their movements may be tracked according to interactions between badges 509-513 and beacons, computers, or other devices as discussed herein. In this example, individual 506 is notified (via badge 511) because 506 is on the same floor as the alert, and closest to the incident. In another example, 505 is not alerted even though this individual wearing badge 510 is on the same floor. The management system automatically determines that this individual is further away from the incident than individual 508 wearing badge 513. Individuals 504 and 508 are closer than 505 or 507, even though 505 is on the same floor.

In another aspect, a zone definition may include multiple areas of a building, or multiple buildings, and transit times between areas may be factored into determining which badges to notify. In this example, the exit 517 on floor 502 is close to the incident (across the hall from room 515) and thus the system may determine that a person on a floor above or below is closer than a person on the same floor. In another aspect, alert device(s) 520-522 are positioned on floors 501-503 respectively. The management system servers of the present disclosure may also activate the alert device 521 on the 2^{nd} floor, while optionally not activating alert devices 520 and 522 on the floor above and below floor 502.

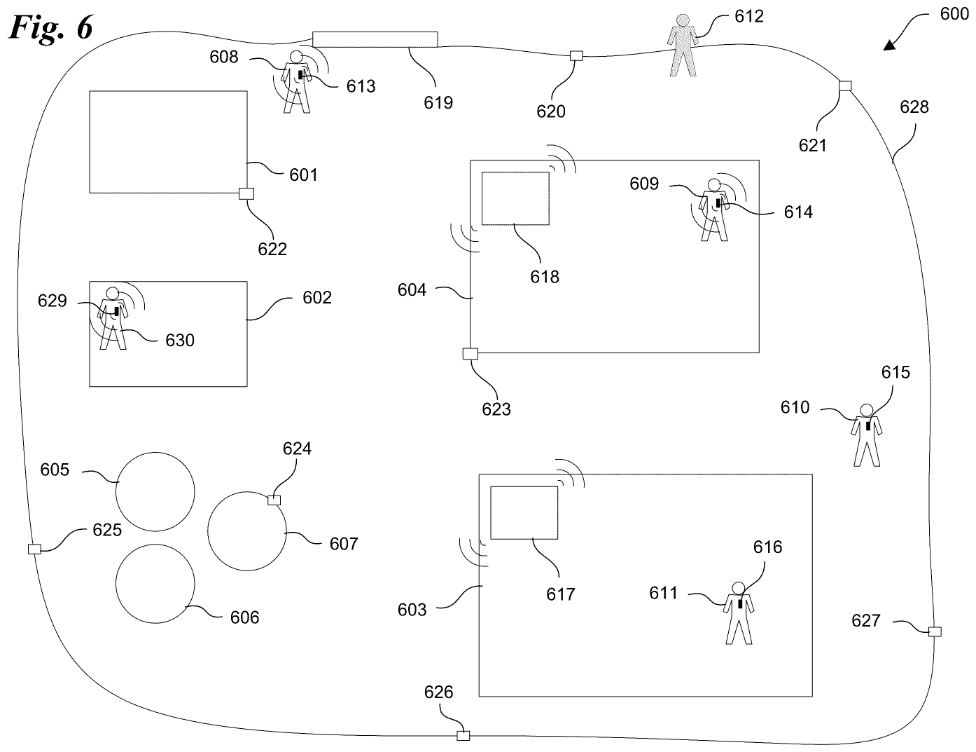

FIG. 6 illustrates another example of the system of the present disclosure at 600. The alert system of the present disclosure is here shown as operating with, or as part of, a security system. A facility or campus is shown that optionally includes one or more buildings 601-604 and other structures such as, for example, tanks 605-607. A fence or other enclosing structure 628 may partially or completely surround the facility and may include a gate 619.

In another aspect, security personnel 613-615 may be wearing badges of the present disclosure while on duty. An intruder alert may be initiated by a security or access control system when an intruder 612 is detected by one or more sensors 620-627 positioned around the facility. FIG. 6 illustrates multiple sensors 620, 621, 625, 626, and 627 included along the fence which are optionally configured to detect a breach of the fence, or detect an intruder passing through, over, under, or around a portion of the fence in order to gain access to the facility. Other sensors may be included as well such as sensors 622-624 which are mounted adjacent buildings or other structures within the facility and are configured to detect nearby movement, or otherwise indicate the presence of a potential intruder. The disclosed sensors 620-627 may be responsive to any suitable sense parameter such as motion, heat, sound, vibration, electromagnetic energy, and may include optical, infrared, or other cameras as well. The security system is optionally configured to raise a security alert based on input from some or all of these sensors, as well as others that may be included.

When a security alert is raised by the security system, the security system may alert the management system via communication links between computers of the two systems which are preferably in regular if not constant communication. The computers of the management system of the present disclosure may then determine the relevant response zone as described above based on various factors such as location and/or qualifications of the available personal, etc. The system may then determine how to respond according to criteria maintained by the management system. For example, the management system may locate the closest three (or any number) of badges and send an alert to those badges thus automatically activating badges 613 and 614 corresponding to individuals 608 and 609.

In another aspect, the alert may provide information to the activated badges including, but not limited to, the precise or general location of the initial sensed intrusion (e.g. “fence—sector 2”, or “building 3”, and the like), a specific sensor that triggered the security system, the type of intrusion detected (motion, vibration, and the like), or any other information collected by the security system and made available to the management system of the present disclosure. In another aspect, the badge may display this information on a screen of the badge, and/or the badge may buzz, flash, etc. as discussed herein. In another aspect, the system may optionally send a “standby” level alert to badge 629 associated with another person 630 optionally indicating that this individual should operate in a standby capacity, such as, to be on the lookout for trouble, to prepare particular tools or equipment for use, but perhaps to not leave their assigned area of duty unless an escalation occurs. This type of “stand by” alert may be used in any context where an alert is sent, regardless of the setting. In another aspect, alert devices 617 and 618 in nearby buildings such as building 603 and 604 may be activated, either by the security system, or by the system management server. These may include lamps, strobes, audible alarms, and the like.

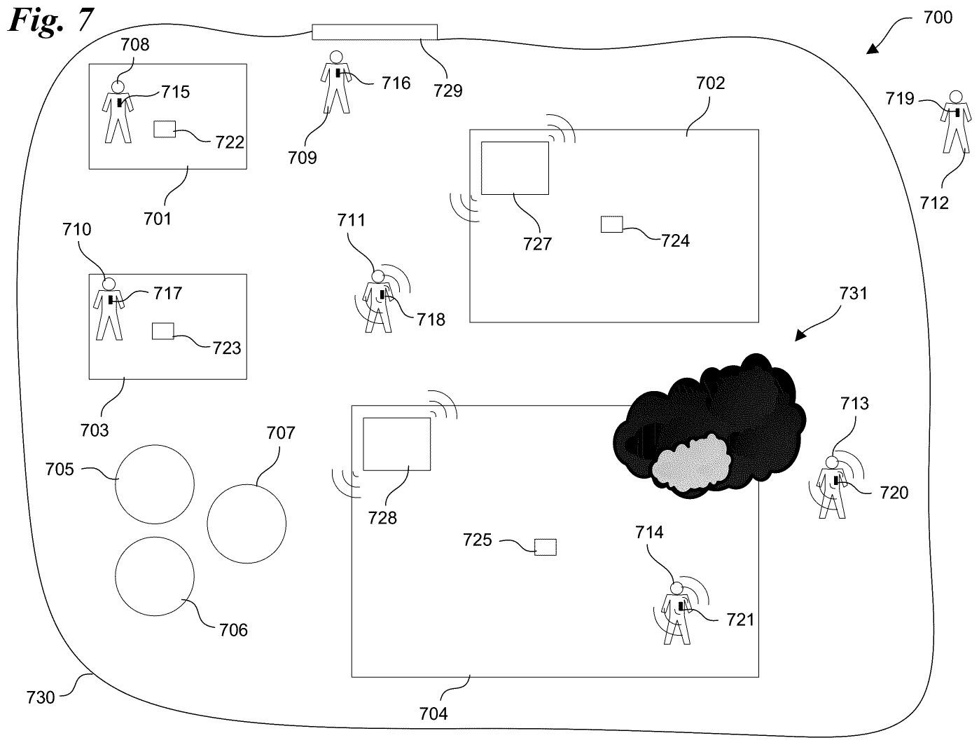

FIG. 7 illustrates another example of the disclosed system operating in a fire or other emergency situation occurring in a facility with multiple buildings. A facility or campus is shown at 700 that optionally includes one or more buildings 701-704 and other structures such as, for example, tanks 705-707. A fence 730 may partially or completely surround the facility and may include a gate 729. In another aspect, personnel 708-714 may be wearing badges of the present disclosure 715-721 and may be adjacent or in the area of the facility.

In one example, the fire or other emergency may be discovered at 731 by a team member 714 who optionally acts upon the disclosed badge providing input via the badge to the management system. This input may include operating a user interface of the badge such as by pressing a button on the badge, touching at least a portion of a touch sensitive screen of the badge, and the like.

In another aspect, a badge of the present disclosure may be configured to automatically detect the emergency situation with or without input from the person wearing it. For example, a badge of the present disclosure such as badge 721, or all of the badges 715-721, may include sensors that are configured to automatically detect an increased level of heat; a concentration of carbon dioxide or carbon monoxide, or other chemicals in the air that is outside threshold levels maintained by the management system and/or by the badge; changes in the movement of the badge such as might be detectable by a motion sensor, accelerometer and the like, where the values detected by the badge are outside threshold levels maintained by the management system, and/or the badge; and/or changes in biometric parameters obtained by the badge that are outside of threshold values maintained by the server and/or the badge such as blood pressure, heart rate, respirations, ambulatory status, blood oxygen levels, blood glucose levels, and the like.

In another aspect, a sensor may be configured to detect a sense parameter triggered by fire, chemical release, high water, particular liquids or gases, or other emergencies. Sensor 725, for example, may be configured to relay signals to the management system defining levels of the sense parameter detected by the sensor. The sense parameter may optionally be received by the security system which may then pass it to the system management server. In another aspect, the sensor 725, and others like it such as sensors 722-724 of other buildings may interact directly with the badge to deliver the sense parameter levels detected by the sensor, and the badge may communicate with the security system or the badge management system to deliver the data, and/or to automatically send an alert to other badges via the management system. For example, the fire at 731 may be discovered by the badge 721 worn by team member 714 when the badge automatically detects an increased level of heat, the presence of a high concentration of carbon dioxide or carbon monoxide, or other chemicals in the air. In another example, the team member 714 may be trapped, unconscious, separated from the badge such as in a fall or accident, and the like, but the badge 721 may automatically generate an alert with or without input from the user.

FIG. 8 illustrates one example of actions the system and users may take to associate a badge with an individual. This type of activity might occur, for example, at the beginning of a shift, at the start of a person's employment during their first day on the job, or as a guest upon entering a space managed by the communication system of the present disclosure to name a few nonlimiting examples. A team member may optionally initiate the process at 801 by entering input into an administrative computing device identifying a business unit or role for the individual who will be using the badge. Examples include, but are not limited to nurse, doctor, Intensive Care Unit (ICU) member, tech support, security staff, and others. At 802, input may be provided defining the user's credentials. Any suitable input may be provided such as a fingerprint scan, a pass phrase or other necessary information via a keyboard, a retinal scan, a spoken word or phrase, and the like, or any combination thereof. The management system may access a security system or other external service to verify the credentials provided are legitimate. These credentials may be verified by the management system of the present disclosure, or be used to indicate either to the management system, to the user, or both, that a login is in process.

At 803, the user may remove a badge of the present disclosure from a docking station or other storage unit. The docking station may notify the management system a badge is being associated with a user, and it may indicate which badge was removed. The management system may check at 805 if a login is in process (initiated at 801 and 802). If no login is in progress (806), the badge that was removed from the docking station is notified and the badge optionally displays a warning message at 807 prompting the user to insert the badge in the docking station, and the process of binding a badge to a user is finished unsuccessfully at 808.

In the case where a login is in progress at 805, the user's credentials are verified, such as by accessing the security or access control system to compare the user's credentials to those maintained by the security system. If the credentials are invalid at 810, a warning message is displayed at 811 optionally on the administrative device and/or the badge, and badge assignment fails at 812.

If the user's credentials are valid at 813, the management system is operable to generate a key and send it to the badge 814. The admin server may also optionally generate multiple candidate keys which may be sent to the administrative terminal at 815. At 816, the user may compare the key on the badge with the keys on the administrative display and select the key on the administrative display that matches the key on the badge. The management system is optionally notified that the badge is now assigned to a particular user and this information may be stored by the remote server. The management system may then automatically update availability records maintained by the management system indicating that this team member is present, and that the badge is now ready to receive alerts.

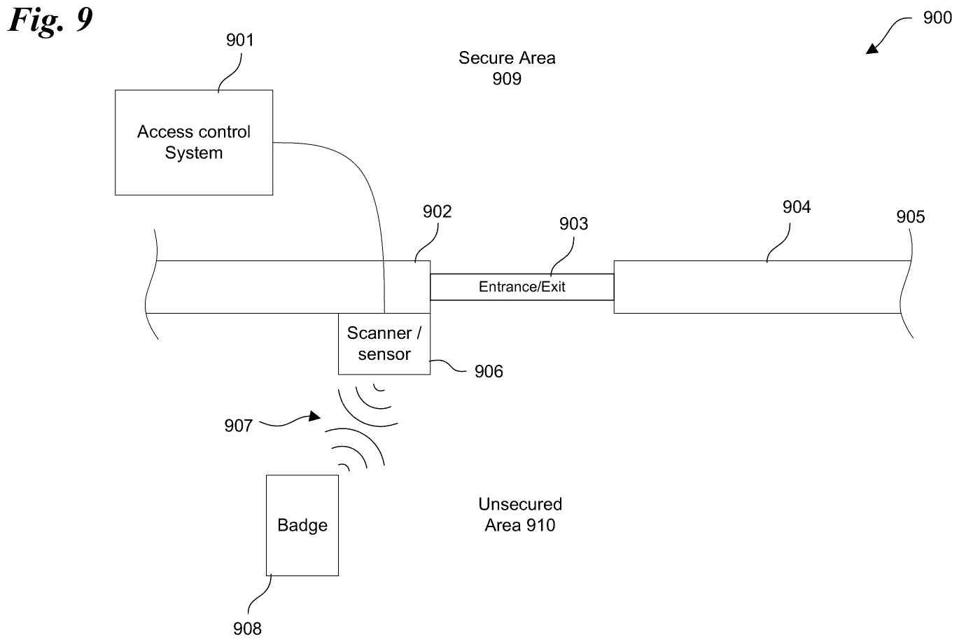

FIG. 9 illustrates at 900 one example of the disclosed communication system allowing access to a secure area. A secure area 909 may be separated from an unsecured area 910 by portions of an enclosure 902 and 904. These may be separated by an entrance or exit 903 which may be any suitable selectively closeable opening such as a door, window, gate, and the like. In one aspect, a badge of the present disclosure 908 may be configured to automatically send and/or receive information about the user via a scanner or sensor 906. The scanner 906 may send the information to an access control system 901 which may execute logic or rules as disclosed herein to determine if access is allowed or not allowed to the person holding the badge. Communication between the badge 908 and the scanner 906 may occur via any suitable wired or wireless technology. For example, the badge and/or the scanner may be configured to transmit or receive electromagnetic radiation 907 of any suitable frequency, and may thereby establish a communication link between the badge and the scanner to facilitate the transfer of information from the badge to the access control system 901 and vice versa. Any suitable protocol may be used such as Near Field Communication (NFC), Bluetooth, WiFi, pulse modulated visible or invisible light, or by optical scanning technology such as in the case of a bar code or QR code for example.

In another aspect, badges of the present disclosure may be associated or coupled to other things besides individual people. For example, a badge may be coupled to a piece of equipment such as a fire truck, fork lift, or other vehicle. In another aspect, a badge may be coupled to individual items in a manufacturing process to track their movements or to detect alert conditions where the item is located and to automatically report those conditions. For example, the badge may be associated with an item to reduce or eliminate the opportunity for tampering, theft, misappropriation, and the like of that item.

Smart badges of the present disclosure may include any suitable hardware and software components and/or control circuitry arranged and configured to implement the features disclosed herein. The control circuitry may be programmed or otherwise configured to implement features and functionality of the smart badge as described in the present disclosure.

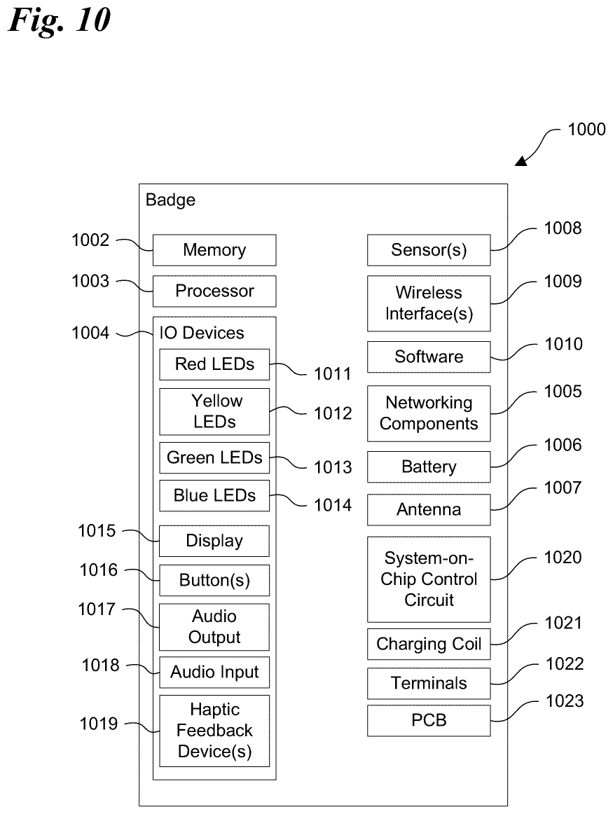

As illustrated in FIG. 10, a badge 1000 optionally includes hardware and software aspects which may include a memory 1002, processor 1003, input/output devices 1004, networking components 1005, a battery 1006, and one or more antennae 1007. Any of these hardware aspects of the control circuitry are optionally included as part of a system-on-chip (SoC) module with integrated memory, processor, antennae and the like. Other aspects discussed herein, or included by reference, may be included as well.

The badge of the present disclosure optionally includes one or more sensors 1008, or is configured to communicate with one or more nearby sensors. These sensors may be able to detect aspects of the environment, or any specific sense parameter including, but not limited to, acceleration, temperature, humidity, heart rate, blood pressure, altitude, movement, orientation with respect to gravity, sound (e.g. microphone), and/or vibration, or any combination thereof.

The disclosed smart badge optionally includes hardware and/or software implementing one or more wireless interfaces 1009. Wireless interface 1009 optionally includes hardware and/or software implementing a Bluetooth or Bluetooth Low Energy (BLE) protocol, any of the various Wi-Fi protocols, any suitable Low Power Wide Area protocol such as LoRa or LoRaWAN, a Near Field Communication (NFC) protocol, a Global Position System (GPS) interface to determine the geographic location of the badge, and/or a cellular data communications such as 3G/4G/LTE/5G and the like for establishing remote communications or determining geographic location via a cellular network, or any combination thereof.

In another aspect, badge optionally includes software 1010 for controlling the badge functions as disclosed herein. In another aspect, hardware or software 1010 may be included for controlling the badge to accept Over-The-Air (OTA) updates. In one example, hardware and/or software 1010 implementing a Bluetooth, WiFi. NFC, and/or a LoRa protocol is optionally included for this purpose, and possibly for others. In another aspect, OTA updates may be managed from a remote server, such as the management system servers of the present disclosure.

The IO Devices 1004 may optionally include one or more Light Emitting Diodes (LEDs) 1011-1014. These optionally include one or more red light emitting diodes 1011, yellow LEDs 1012, green LEDs 1013, and/or blue LEDs 1014. Any one, or any combination of these, may be activated and deactivated as needed to provide output notifying a nearby individual (such as the person wearing the badge) that an alert has been received by the badge. In one aspect, the LEDs 1011-1014 may be configured to emit light only at an intensity greater than 60 millicandela (med). Alternatively, the LEDs 1011-1014 may be configured to emit red, green, blue (RGB) or other colors of light at an intensity greater than mcd. In another aspect, LEDs 1011-1014 may be operable to emit multiple different colors and may be programmable or controllable to emit combinations of red, green, and blue (RGB) light to provide for a range of colors according to different combinations thereof.

In another aspect, LEDs 1011-1014 may activate and deactivate to provide different colors at different times to indicate changes in alert levels or severity. In another aspect, a change in the color of the LEDs may indicate an escalation and that more resources have been notified as disclosed herein.

In another aspect, the badge 1000 may be configured with software and/or hardware operable to active and deactivate the LEDs 1011-1014 according to different color arrangements or patterns of flashing LEDs which may be optionally provided to indicate different alert statuses. For example, all red LEDs 1011 flashing may indicate a safety alert, and the rate of flashing may indicate an alert level which may indicate the severity or overall level of concern. For example, a lower rate of flashing per unit of time may indicate a lower severity, and a higher rate of flashing may indicate a higher severity.

In another aspect, a flashing yellow LED 1012 optionally indicates a reminder, warning or notice, or perhaps a raised level of concern (warning level). A change in the rate of flashing may indicate a change in severity level for the yellow LEDs 1012 (as well as optionally for any other colors of LEDs). A green LED 1013 may be activated temporarily when an alert has been resolved.

In another aspect, flashing blue LEDs 1014 optionally indicate a notification or other new information that may be beneficial to the user. Flashing green LEDs 1013 optionally indicate a successful result such as permission to enter, a successful software update, a successful pairing operation between a user and the badge (discussed above), etc. Multiple LEDs 1011-1014 may be activated in any suitable pattern or intensity. In another aspect, the LEDs 1011-1014 may be multicolor LEDs capable of a wide range of different colors of light. Thus only one LED may be needed to emit red, yellow, green, or blue light, or multiple such LEDs could be included to enhance the light emitted, or to provide further options for adjusting the color of the emitted light. Also, a badge of the present disclosure may include hardware and/or software drivers for implementing pulse width modulation (PWM) for the LEDs 1011-1014 to control frequency of activation and perceived intensity and/or color where multiple colored LEDs are included.

A badge of the present disclosure optionally includes a display device 1015. The display device 1015 may include an LED screen, an e-ink screen, and the like. The display device 1015 may include backlighting lamps or it may be free of backlighting. Display device 1015 may optionally be touch or pressure sensitive. In another aspect, the badge may be operable to allow the display to remain on thereby displaying information about the user associated with the badge, any alert information, etc. throughout an 8 hour shift, a 12 hour shift, or longer. This “always on” feature may be especially useful in instances where a picture of the person wearing the badge is required to be on display at all times or where important information about an incident and the associated alert message is required to be on display at all times.

In another aspect, a badge of the present disclosure optionally includes haptic feedback devices 1019. Such devices may, for example, be configured to cause vibration that may be felt by a person wearing the badge when an alert is sent to the badge.

A badge of the present disclosure optionally includes an audio output 1017 such as a speaker, buzzer, or other audible output device configured to generate sound. Such sound is optionally generally audible to a human or animal. An audio input device 1018 may include a microphone or other transducer for converting sound to electrical signals which may be processed by processor 1003 or sent to a system management server for processing.

In another aspect, a badge of the present disclosure optionally includes one or more switches or buttons 1016 for accepting input from the user. In one example, buttons 1016 include a momentary tactile switch for providing input from a user. This switch may be configured as a user input button to signal an alert thus providing input to the management system to activate other badges in the area, to marshal additional resources, and the like, as disclosed herein. In another example, the switch may be configured to accept input indicating that the user acknowledges that alert has been sent to that particular badge, and/or the user is responding accordingly. In another aspect, buttons 1016 optionally include a reset button that may be operable to reset the processor, to reset the badge in preparation for use by another 30 user, or to restart the badge for the existing user.

In another aspect, a badge of the present disclosure optionally includes an internal power source such as a battery 1006 arranged and configured to provide power to the badge and to some or all of the components thereof. The battery 1006 is optionally configured to provide sufficient power to operate the badge for at least four hours, or at least 8 hours, or at least 12 hours or more without a recharge. In another aspect, the battery 1006 optionally includes an integrated fuel gauge chip. This fuel gauge chip may optionally be included in the control circuitry of the badge separate from the battery 1006. The fuel gauge chip is optionally configured to provide an alert when low battery life is detected. In another aspect, the battery adheres to the UL2054, UL1642, or IEC61233 requirements.

In another aspect, a badge of the present disclosure optionally includes system-on-chip (SoC) control circuitry 1020 that includes multiple processor cores. In one example, the SoC architecture includes a first core for user applications, a second core for managing Wi-Fi, and/or a third core for managing communications via Bluetooth low energy (BLE). The circuitry 1020 may include SoC architecture configured to run an ARM processor configured to provide secure boot functions for the badge. The badge optionally includes a supervisor chip to hold the processor in the reset state during power up.

In another aspect, the badge optionally includes hardware, circuits, and/or software implementing a board revision monitoring system. The board revision monitoring system may include a voltage divider and an analog channel, and the voltage divider may optionally include one or more resistors.

In another aspect badge includes other hardware interface features for interacting with peripherals such as a synchronous, multi-master, multi-slave, packet switched, single-ended, serial communication bus (e.g. I2C), Serial Peripheral Interface (SPI), Quad Serial Peripheral Interface (QSPI), Universal Asynchronous Receiver/Transmitter (UART), Pulsed Width Modulation (PWM), General Purpose Input Output (GPIO), and/or Analog to Digital Converter (ADC) or Digital to Analog Converter (DAC) to name a few non-limiting examples.

In another aspect, a badge of the present disclosure optionally supports image transfers to and from the badge. The image transfers may be made via Wi-Fi, Bluetooth, NFC, or other suitable communications technology or protocol. The image transfers allow for the badge to selectively display a particular image which is optionally kept in the memory 1002 of the badge and is maintained in nonvolatile or other such storage so that it is not erasable. The badge 1000 optionally includes a physical terminals 1022, one or more passive components, and a serial peripheral interference (SPI) communication bus, and is programmed or otherwise configured to receive graphics data streamed wirelessly from a remote server. For example, streaming optionally occurs automatically on charging in a charging base station.

The badge optionally includes a charging coil 1021 and/or terminals 1022. The coil 1021 may be useful for wirelessly transferring power from a corresponding coil in a base station or other charging platform to the battery 1006. One or more terminals 1022 may optionally contact corresponding terminals of a base station, charging cord, and the like to provide power transfer to the battery 1006. Other uses of terminals 1022 include data transfer such as in the case of a remotely managed upgrade, or images or other personal information transferred from the management system to the badge when the badge is paired to a user.

In another aspect, a badge of the present disclosure optionally includes a Printed Circuit Board (PCB). The PCB optionally includes 4 copper layers for a total thickness of 1 mm. The badge optionally includes a PCB mounted speaker operable as an audio output device 1017. The badge may be configured to activate the speaker or other audio output device 1017 to optionally alert a user. In another aspect, the badge optionally includes a PCB mounted vibe motor operable as a haptic feedback device 1019 providing touch sensitive feedback. The badge may be configured to provide haptic feedback in conjunction with the audible alarm. In another aspect, the badge of the present disclosure may include a housing containing some or all of the disclosed components. The housing may be partially, or hermetically sealed to avoid or eliminate fluid intrusions. For example, the housing may be sealed against water according to the IP65 standard.

The badge of the present disclosure may be used in conjunction with a system for monitoring patient activity in a hospital, clinic, nursing home, or other facility where a patient may be receiving care. The patient monitoring system is one example of a facility monitoring system 114 illustrated in FIG. 1. More specifically, the disclosed patient monitoring system involves detecting patient activity and analyzing this data in real time to predict when a patient is likely to stand, which may lead to a fall, for example, from a bed, chair, or other supporting structure. When the patient monitoring system determines that a fall is imminent, nearby caregivers may be alerted and can then offer timely assistance thus increasing the chance of avoiding a fall before it happens. In another aspect, the patient monitoring system of the present disclosure may be operate in concert with the disclosed communication and alert system that uses the badges of the present disclosure.

The disclosed patient monitoring system optionally includes a monitoring device with one or more sensors such as a pressure sensor, accelerometer, gyroscope, temperature, proximity, or sensor that may be positioned on or near a patient. The monitoring device may receive updated sensor readings and can report this information to a central server. The server may then alert caregivers who are close by informing them that the patient's activities indicate a risk of an imminent fall.

Illustrated in FIG. 11 is one example of components that may be included in a patient monitoring system 1100. Patient monitoring system 1100 may include a patient monitoring device 1108 for detecting movements, combinations of movements, positional changes, and other patient related activities or events that may indicate a patient is about to fall. Monitoring device 1108 may be coupled to a patient 1120, for example, via a belt, an ankle bracelet, an armband, or as part of article of clothing such as a sock, shirt, gown, and the like. Patient monitoring device 1108 may communicate with a server 1102, a data store 1104, a computer 1106, and any other devices in the system using a communications link 1118 and a network 1110. In one example, a computer 1106 may be configured to discover what patient monitoring devices 1108 are nearby using network 1110, and may be configured to allow a caregiver using a computer 1106 to select from which patient monitoring devices to monitor and receive alarm information. Examples of a computer 1106 include, but are not limited to, a badge of the present disclosure, a local computer 105, an in-room computing device 305, or an admin computing device 311, or any other such device suitable for patient monitoring.

In another aspect, servers 1102 may be included as part of the disclosed management system illustrated in FIG. 1 at 107 and discussed throughout the present disclosure. In another aspect, the management system 107 and server 1102 may be separate systems that operate independently but communicate via a computer network. In any case, alerts raised by the patient monitoring system are optionally broadcast using the disclosed communication and alert system to nearby badges as discussed herein elsewhere. Thus the patient monitoring system may operate as a separate system that uses the communication and alert system, or the two systems may be integrated together to use the same servers, network, data storage, local computers, tablets, smart phones, and so forth. Functionality described herein may be implemented in a single applications, or suit of applications, providing both monitoring and alert broadcasting services to the disclosed smart badges, or the functionality may be separately implanted as different systems running different applications and using different hardware.

Looking closer at the patient monitoring system, server 1102 may communicate with other devices 1104, 1106, and 1108 via network 1110 and communication link 1112. Server 1102 may be configured to perform various tasks such coordinating the analysis and storage of alarm related information and/or storing and analyzing event or sensor data from devices 1108. Server 1102 may be configured accordingly to accept event or alert information from a monitoring device 1108, and determine what caregiver(s) should receive alerts for a given patient. Server 1102 may make this determination based on criteria such as the caregiver's proximity to the patient, the patient's condition, the caregiver's specialties, and the like as discussed herein. In one example, alerts sent from a patient monitoring device are sent to server 1102 and distributed to the appropriate caregiver when a patient monitoring device 1108 indicates patient activity that may be outside the parameters set for that particular patient.

Data store 1104 may be configured to store and provide access to information obtained as a result of monitoring patient activity. Data store 1104 may include alarm information, patient activity data as captured by various sensors in patient monitoring devices 1108, contact information and/or access credentials for caregivers, and/or a database of default patient profiles or profile parameter information to name a few non-limiting examples. Data store 1104 may include, or may communicate with, the data storage and analytics system 110, and/or with other such systems discussed herein which are suitable for storing and processing data.

As disclosed in further detail below, the patient monitoring device 1108 is configured to detect patient activity using various sensors, and to analyze that activity in real time to determine if it indicates a patient is likely to stand or fall. If a potential stand or fall event is detected, the monitoring device can send an alert notifying the server 1102. The server can broadcast the alert to all or a subset of nearby caregiver badges or other alert devices giving them the opportunity to provide assistance before the patient falls.

Responding caregivers can also indicate whether the alert was warranted by communicating the patient's current situation back to the monitoring system using a computer 1106 such as a tablet, smart watch, or smart phone. The server can use data store 1104 to store this feedback from the caregiver, along with data values collected in real time by the monitoring device in the moments leading up to the alert. This data can then be analyzed by server 1102 to determine what adjustments to the logic or configuration of the monitoring device should be made, if any, to increase the system's accuracy in predicting patient falls. The system's overall accuracy is thus improved by facilitating feedback from caregivers about whether the predicted fall was actually about to happen, actually did happen, or that a patient fell before any alert was raised.

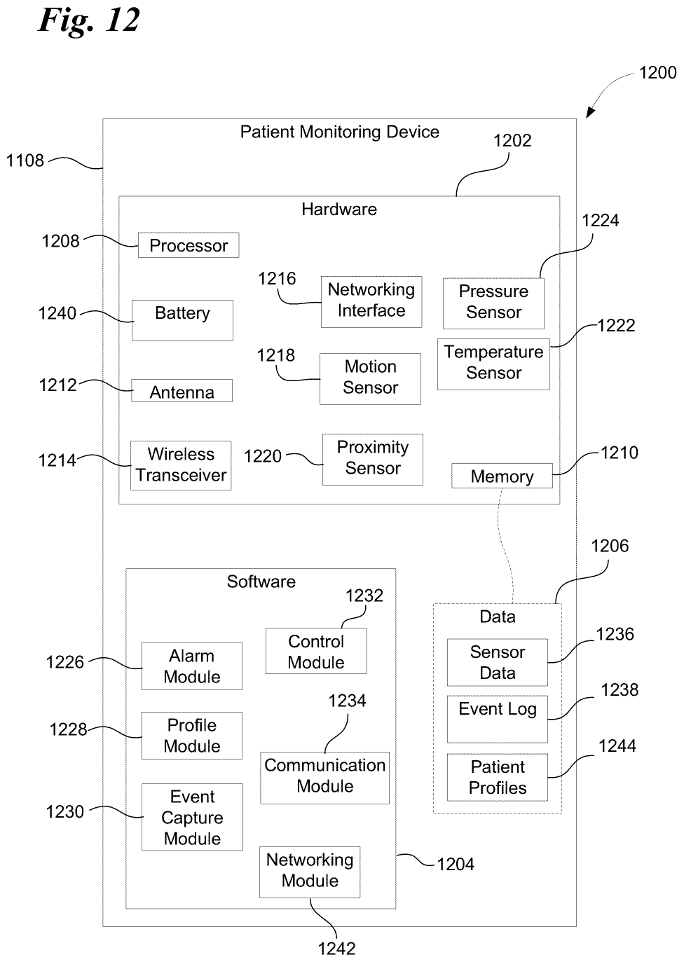

Additional detail of the software, hardware, and data aspects of a system like the one illustrated in FIG. 11 is further illustrated in FIGS. 12-17. FIG. 12 illustrates at 1200 one example of an arrangement of components for a patient monitoring device like monitoring device 1108. Monitoring device 1108 may generally include hardware 1202, software 1204, and may also include a local data store 1206. Any suitable arrangement of hardware or software modules may be used.

Hardware 1202 may include a processor 1208 which may be programmed to perform various tasks discussed herein related to monitoring patient activity. Processor 1208 may be coupled to other aspects of hardware 1202 such as sensors, memory, and the like to perform these tasks. Memory 1202 may be included for storing operating values or parameters which may include intermediate or final values of calculations, logical or computational instructions for processor 1208, or hardware control parameters. Memory 1202 may also store patient monitoring information such as patient related events in an event log 1238, sensor data 1236 obtained from sensors coupled to the patient monitoring device, and/or patient profiles 1244 for controlling how data about patient activity is collected and analyzed. Memory 1202 may be either a permanent or “static” memory, or a temporary or “dynamic” memory, or any combination thereof.

An antenna 1212 may be included to facilitate wireless communications over a communication link like communication link 1118. A networking interface 1216 may be included to process communications with other devices in the system communicated using a network such as network 1110. Wireless transceiver 1214 may be included and may use antenna 1212 or other suitable hardware 1202 to transmit and receive information between patient monitoring device 1108 and other devices in the patient monitoring system such as server 1102, data store 1104, and/or computer 1106.

Patient monitoring device 1108 may include one or more sensors such as a motion sensor 1218 configured to detect a patient's movements. Motion sensor 1218 may be any suitable device or devices responsive to the movement of the patient and may include, for example, one or more accelerometers to detect movement in multiple axes relative to gravity, and/or one or more gyroscopic sensors for detecting changes in angular momentum and/or an angle of elevation. Motion sensor 1218 may be used to detect when a patient changes position to get out of bed, or abruptly falls to the floor from a standing position, or from a supporting structure such as a bed, chair, wheelchair, and the like.

Hardware 1202 may also include proximity sensor 1220 configured to generate signals based on distance from a target object or location. For example, a sensor target object such as a magnet, a radio transmitter, or other target may be positioned in or adjacent to a chair or bed, or other reference point. Proximity sensor 1220 may determine the distance between sensor 1220 and the sensor target and provide this information as a time varying signal to other software or hardware components of patient monitoring device 1108. For example, this proximity data may be processed by processor 1208 according to software 1204 and used to determine when a patient has traveled beyond a predetermined threshold distance from the sensor target as defined in the patient's profile.

A pressure sensor 1224 may also be included, and may be useful for detecting changes in the distribution of pressure on a patient's body. For example, pressure sensor 1224 may detect an increase in pressure in one body part, and a decrease in pressure in another as a patient moves from laying down to being seated upright. Pressure sensor 1224 may also detect rapid drop in pressure on a particular body part when a patient is falling, and a subsequent rapid increase in pressure when the patient lands abruptly on a support surface such as the floor or the ground.

The temperature sensor 1222 may also be included to provide further information about patient's location, position, and/or overall health. For example temperature sensor may be useful for determining when a patient removes the sensor from their body, when a patient moves outside a facility, or enters an environment that causes a large change in the patient's temperature, or in the temperature of the environment.

Any of the sensors used by patient monitoring device 1108 such as sensors 1218, 1220, 1224, 1222, and others, may be mounted inside or outside a housing containing some or all of the other hardware and software components. For example, patient monitoring sensors may be mounted outside a container or housing and may communicate with hardware and software inside the housing by any suitable communications link. For example, pressure sensor 1224 may be woven into a patient's clothing such as into a sock or gown, and may communicate with components of software 1206 and hardware 1202 mounted inside the housing via a wired or wireless communications link. This communications link may be maintained as electromagnetic signals traveling over wire leads, or through the air as radio waves using any suitable wireless communication technology.

These hardware aspects of patient monitoring device 1108 may be configured to operate according to instructions included in software 1204. These instructions may be logically or conceptually arranged as modules for controlling different functional aspects of the patient monitoring device. Functional aspects generally include obtaining, storing, and processing data from multiple sensors, detecting patient activity, determining when to send alert notices to other parts of the system, retrieving or updating patient profile information, and/or sending sensor data to a central archive to improve the performance of patient monitoring devices throughout the system.

Software 1204 may include an alarm module 1226 configured to send alarm related messages, events, or data to other parts of patient monitoring system 1100. Alarm module 1226 may determine when to send alert information notifying caregivers when a change in a patient's situation warrants immediate investigation. Alarm module 1226 may include rules for determining under what circumstances an alert should be sent. In one example, alarm module 1226 uses a patient profile 1244 that has one or more patient related parameters with corresponding predetermined threshold values. These values may be used to determine when patient activity warrants further investigation.

Examples of alarm rules include a pressure rule that is triggered when signals are received from alarm module 1226 that indicate changes in position or other activity that may have caused pressure differentials in the patient's feet or other monitored locations that are outside the predetermined threshold values in a patient profile 1244. Such pressure sensor rules, when triggered, configure patient monitoring device 1108 to send an alert indicating that changes in the pressure distribution of a patient's weight relative to a support surface no longer match the predetermined patient profile. In one example, the patient has been prescribed bed rest resulting in a predetermined target distribution of weight across the patient's back and legs stored in patient profile. This weight distribution may be periodically or continuously detected by pressure sensor 1224 as signals sent from the pressure sensor to other parts of patient monitoring device for processing and storage. When a patient moves, such as to an upright seated position, pressure sensor 1224 may begin sending different signals indicating a different distribution of weight that no longer matches the patient's profile. A rule in alarm module 1226 may then be triggered to send data, message, an event, or any other suitable series of instructions or data to other parts of the patient monitoring system indicating that the patient has changed position.

In another example, alarm module 1226 may include motion rules that may be triggered when motion sensor 1218 indicates movement that falls outside the predetermined threshold values in patient profile 1244 that are related to motion. Such motion related parameters in the patient profile 1244 may include any combination of movement in general areas such as the patient's extremities, torso, or in specific areas such as movement of the head and neck, movement of an arm and/or leg, and the like. Such movement may include changes in the speed, acceleration, or angle of incidence relative to gravity for a give part of the patient's body. Patient profile 1244 may be stored in memory 1210 along with other relevant data and may be used to maintain these parameters which may be generic to many patients, or specific to the particular patient wearing monitoring device 1108.

In another example, the alarm module 1226 may include proximity rules that are triggered when a patient travels beyond a predetermined distance from a target location such as a bed, chair, or other supporting surface. For example, proximity sensor 1220 may send signals continuously or at regular intervals to patient monitoring device 1108 indicating the range to the target object. When the patient moves, proximity sensor 1220 may send different signals indicating a change in distance to the sensor target. The rule in alarm module 1226 may be triggered to send information to other parts of the patient monitoring system in the event that proximity sensor 1220 indicates a range from the sensor target that exceeds a predetermined threshold in the patient's profile 1244.

In yet another example, alarm module 1226 may include motion sensor rules that when triggered, configures patient monitoring device 1108 to send alerts when the patient's movements do not match the patient's profile. Using motion sensor 1218, patient's movements may be periodically or continuously processed by patient monitoring device 1108 as signals from the motion sensor change over time. At some point, patient's movements may change causing motion sensor 1218 to send signals indicating a movement or series of movements that no longer match the patient's profile. A motion sensor rule in alarm module 1226 may then be triggered to send event data to other parts of the patient monitoring system indicating that the patient's movements suggest activity that is outside the patient's predetermined thresholds in the patient's profile and thus may be or detrimental to the patient.

Alarm module 1226 may be programmed with any suitable series of rules comparing the current state of patient monitoring device 1108 to one or more predetermined threshold values. For example, alarm module 1226 may include rules that are triggered based on combinations of input from multiple sensors received over time. These combinations may be defined in a monitoring rule, or in patient profile 1244. In this way, one or more combinations of signals from one or more sensors may be considered over specific time intervals allowing for more complex considerations of data received from motion sensor 1218, pressure sensor 1224, temperature sensor 1222, proximity sensor 1220, and any other sensors that may be employed.

In another example, alarm module 1226 may be configured with one or more status related rules. Such rules may include a wireless networking rule configured to trigger when wireless transceiver 1214 reports signal strength from nearby wireless devices has fallen below a predetermined threshold. Another status rule may include a battery monitoring rule configured to trigger when the state of charge for a battery 1240 is below a predetermined threshold. Others such status rules may include an error reporting rule configured to trigger when a hardware or software error condition occurs, when available storage capacity in memory 1210 is below a predetermined threshold, and the like.

Alarm module 1226 may also be programmed to include an alert level, severity level, level of importance, or other similar flag or indicator to assist the patient monitoring system in prioritizing, categorizing, or managing the response to alarms or alerts that may be raised. Alarm module 1226 may include rules for calculating this priority level. For example, an alarm rule may be configured to set the severity level of an alarm to indicate a high degree of importance in the case where a particular threshold value (e.g. patient's movements) exceeds parameters set in the patient's profile by greater than a predetermined severity level threshold. Priority levels may be indicated in any suitable fashion such as a range of numbers zero through nine or zero through a hundred and the like, or a “high”, “medium”, and “low” indicator.

For example, if a patient's movements exceed parameters in the patient profile by less than 10%, alarm module 1226 may generate an alarm with the severity level that is at a lower level such as zero or one or “low”. When the patient's movements exceed the upper range of a patient's profile by for example 10-30%, a higher level may be assigned such as a three, or four or a “medium” indicator may be used. For situations where patient movement exceeds the patient's profile parameters by greater than 30%, a “high” indication may be assigned to the alert information, or a value such as eight or nine. This is but one non-limiting example as any suitable scheme for prioritizing alarm information may be used.

Profile module 1228 may be configured to accept or modify or otherwise maintain a patient profile 1244. Patient profile 1244 may include multiple parameters detailing information about the patient, the patient's treatment plan, and other information useful to patient monitoring device 1108 and the rest of patient monitoring system 1100. A patient profile may include any information about the patient useful for predicting and preventing patient falls. Such information may include detailed patient measurements such as medical condition, height, weight, body composition, treatment plans, drug regimens, and the like. It may also include demographic information such as sex, race, and the like.

For example, a patient profile may include parameters indicating whether a patient should be allowed to move away from a supporting surface such as a bed or chair, whether the patient should be allowed to assume a particular posture or position such as standing, walking, sitting, laying down (left and/or right side), and the like. A patient's profile may indicate under what circumstances a patient may leave the room, or how often the patient should be repositioned in place.

Parameters, or parameter ranges may be specified in any suitable format such as numbers, letters, binary data, and the like. For example parameters may be organized to correspond with input values required by one or more rules in alarm module 1226. In another example, patient parameters may be configured to correspond with output ranges of specific sensors or combination of sensors used by patient monitoring device 1108. The patient parameters may be thought of as predetermined threshold values that may be compared to sensor or other data according to a rule. These predetermined threshold values may be specific values or ranges of values, with or without accompanying tolerances. Such values may be numerical, textual, or any combination thereof.

An event capture module 1230 may be configured to collect available event related information to send out to other parts of patient monitoring system when an event occurs. This information may include a snapshot of the patient's present condition and state as determined by the sensors in patient monitoring device 1108. A current reading from the motion sensor 1218, proximity sensor 1220, pressure sensor 1224, temperature sensor 1222, and/or the state of various subsystems in patient monitoring device 1108 such as battery 1240, memory 1210, or any combination thereof. Event data may also include the rule triggered, date and time stamp, and the like.

Event capture module 1230 may collect event information when alarm is triggered, or periodically to provide patient monitoring system 1100 with an ongoing regular status update of the patient's condition, position, activity, and the like. Event capture module may include rules specific to general event capture irrespective of whether an alarm state has occurred. For example, an event capture rule may store event information in an event log 1238 in memory 1210 when patient activity occurs but is not outside the parameters specified for such activity in patient profile 1244. This may be advantageous in providing “baseline” values for the state of a patient leading up to an alarm condition when it occurs. Event data may be stored in event log 1238 and transferred to data store 1104.

Other contextual information may be collected as well and sent along with an alert or event update. Such contextual information may include signals or other data received from sensors or other parts of patient monitoring device 1108 for a predetermined time period prior to the alert being sent. For example the alarm module may collect all data obtained or received by patient monitoring device 1108 for the last 60 seconds before the alert was sent, for the last five minutes before the alert was sent, for the last half an hour, or for some period of time greater than a half an hour. In another example, the transmission of data may be 1.5 based on a number of events rather than a specific period of time. This data may include all available monitoring data, or some portion of the data as determined by the triggered rule, or by alarm module itself to 1226.

In one example, when a motion sensor rule is triggered, the rule may be configured to collect the preceding two minutes of motion sensor data and/or the preceding five minutes of pressure sensor data to be sent with the alarm message. In another example, alarm module 1226 may be configured to collect the preceding five minutes of data from some sensors (e.g. pressure sensor, proximity sensor, and or motion sensor) but not others (e.g. temperature sensor). In another example, stored data from all sensors may be collected by 1226 after a predetermined number of events have been detected and stored from a number of different sensors. This kind of “pre-alarm” data may be used by other parts of patient monitoring system to detect patterns of sensor data that indicate certain patient activity is imminent or to determine probabilities of false positives and false negatives. This information can be used to refine when rules should trigger.

Assembled data may be organized into an alarm message which may include the current snapshot of the patient's condition and any other information related to the alarm that may be useful to other parts of the patient monitoring system. The message may be transmitted over a communication link using networking interface 1216 to be processed by a server such as server 1102, or seen by an operator at a computer such as computer 1106. The data may be stored in data store 1104 along with associated sensor data.

Control module 1232 may be included to organize the operations of software 1204 and/or hardware 1202. Control module 1232 may be configured to initialize the activity of patient monitoring device 1108 such as going through a basic startup and testing procedure, running through algorithms or subroutines to locate and communicate with server 1102, data store 1104, computer 1106, and or other devices in the patient monitoring system. Control module may then begin one or more control loops periodically or continuously obtaining sensor data from one or more sensors in the patient monitoring device such as pressure sensor 1224, motion sensor 1218, proximity sensor 1220, and or temperature sensor 1222 or others. Control module 1232 may be thought of as a “controller” that controls the operation of patient monitoring device 1108.

A communication module 1234 may be included as well. Communication module 1234 may be configured to open and maintain communication links to various other parts of the patient monitoring system such as server 1102, data store 1104, and others. Communication module 1234 may be configured to implement any suitable digital, analog, or other communication scheme using any suitable networking, or control protocol. Communication module 1234 may engage or use networking module 1242 to open, maintain and manage communication links with other aspects of the patient monitoring system via network.

In one example, communications module 1234 may be configured to automatically establish communication link 1118 with network 1110. Patient monitoring device 1108 may be configured to operate according to the IEE6802.15 wireless networking standard (sometimes referred to as a “Bluetooth” or Wireless Personal Area Network or “WPAN”). In this example, communications module 1234 may automatically interact with routers, switches, network repeaters or network endpoints, and the like to establish a communications link 1118, and/or 1112 so that event updates may be automatically configured to pass to server 1102 where they may be processed and distributed. Communications module 1234 may be implemented to use any combination of Generic Access Profile (GAP), Generic Attribute Profile (GATT), and/or Internet Protocol Support Profile (IPSP) protocols to acquire and maintain communications with server 1102, data store 1104, and/or computers 1106.

Monitoring device 1108 may maintain data 1206 which may include sensor data 1236, event log 1238, and one or more patient profiles 1244. Data 1206 may include diagnostic information, timestamps and other contextual information related to actions taken by patient monitoring device 1108, alarm messages sent, raw sensor data, and the like. Data 1206 may be accessed by other software or hardware in patient monitoring system 1108. Data 1206 may be periodically refreshed or deleted to optimize use of memory 1210.

Stored patient profiles 1244 may include default parameter values general to many patients, or parameter values specific to one patient. These parameter values may be refreshed periodically from time to time such as by a firmware upgrade, by replacing a memory card, or via communications link 1118. Profile parameters may be analyzed and processed on another computer such as server 1102 and periodically sent to patient monitoring device 1108.

One example of software and hardware components that may be used to implement a server such as server 1102 for the purposes of patient monitoring is shown in FIG. 3 at 1300. Server 1102 may include any suitable combination or arrangement of hardware 1302 and software 1304. For example, server 1102 may include a processor 1305 that can be configured or programmed to perform calculations related to generating and maintaining patient profiles, maintaining current locations for patients being monitored, receiving and propagating alarm or event information, and/or analyzing historical results from previous alarm situations. Other components in the system such as computers 1106, patient monitoring devices 1108, and data store 1104 may communicate with server 1102 to collect and or receive this information as events unfold for the patients being monitored.

Communication between server 1102 and other parts of the system using communications links may be facilitated by transceiver 1314. For example, communications links 1112, 1114, 1116, and 1118 may be implemented via any suitable wireless technology such as Wifi, Bluetooth, and others using transceiver 1314 and antenna 1308.

Server 1102 may include user I/O devices 1310 which may include any suitable devices for accepting input from a user such as keyboards, mice, or other I/O devices. For example, devices 1310 may include a touchscreen, one or more buttons or other controls on a control panel coupled to or integrated with server 1102.

Server 1102 may include a networking interface 1312 for communicating with other parts of the patient monitoring system such as the data store 1104, computers 1106, and the like. Interface 1312 may interact directly with network 1110 through a wired or wireless communications link. For example, a communications links like communications link 1112, 1114, 1116, and 1118 may connect server 1102 to a computer 1106. A memory 1306 may be included as well for temporarily or permanently storing sensor data, profile data, logical or computational instructions, and the like.

A display device may be included as well for displaying a user interface such as a Graphical User Interface (GUI) generated by server 1102. The GUI may include graphical controls for managing or maintaining aspects of server 1102 and/or other components of the patient monitoring system. For example, the GUI may be configured with controls for calculating or generating new patient profiles, manually overriding alert messages sent from a patient monitoring device 1108 (e.g. marking a result as a “false positive” or “false negative”), upgrading software in server 1102, in patient monitoring devices 1108, and/or in computers 1106. Display device 1316 may be a touchscreen programmed to perform these or other tasks using any suitable configuration of text, graphics, and/or GUI controls such as check boxes, drop-down lists, text fields, buttons, and the like useful for accepting input and displaying output.

Software components of server 1102 may include a patient event module 1338 which may configure processor 1305 and other components of server 1102 to process information about activities or events taking place with monitored patients. Event or alarm messages may be generated by patient monitoring device 1108 and may include about a patient's disposition as detected by a patient monitoring device 1108. For example, as discussed herein elsewhere, patient monitoring device may detect the patient has changed position from a laying down to sitting up, rolling from the left side to a right side or vice versa, has begun to walk around a room, or has fallen from a support surface such as a chair or bed. Event module 1338 may be configured to receive these events or alarms, and determine how they should be processed and/or stored by server 1102. For example patient event module may configure server 1102 to communicate event data to data store 1104 for long-term storage or future processing. Patient event module 1338 may also configure server 1102 to communicate with other computers such as computers 1106 operated by caregivers and others.

Event capture module 1230 in a patient monitoring device 1108 may communicate event or alarm messages to patient event module 1338 as they occur. For example, patient monitoring device 1108 may collect information with one or more sensors such as a motion sensor 1218 and the like, and may determine by rules in alarm module 1226 that the event does not fall outside profile parameters in the patient profile. Thus no alarm may be generated. However, event capture module 1230 in the patient monitoring device 1108 may deliver the event information to server 1102 where it may be received by and processed by patient event module 1338. Patient event module 1338 may store, process, or otherwise perform logic functions on the event as well. In this way, patient monitoring device 1108 may maintain periodic or nearly constant communication with server 1102 collecting information about patient activities which may be processed in the future to detect false positives, false negatives, or otherwise refine the event collection and alarm process to better ensure patient safety and adherence to treatment plans.

When alarm module 1226 in the patient monitoring device determines that patient activity is outside the predetermined thresholds in the current patient profile 1244, an alarm or alert may be generated by patient monitoring device 1108 which may be communicated to server 1102 and handled by alarm module 1326. Alarm module 1326 may process the alarm information received from patient monitoring device 1108 according to one or more 1.5 processing rules for handling the alarm.

For example, rules in alarm module 1326 may be configured to process and route alarm information through communications link 1116 to one or more computers 1106. These rules may use any information in an alarm or event to determine which computers associated with particular caregivers are to receive information. For example, the information may be routed based on severity level included in the alarm with “high” priority alarms sent to multiple individuals so that these individuals can converge on the patient to provide faster assistance. In another example, an alarm may be sent a single individual regardless of severity. The information in the alarm may be presented to the user of computer 1106 by any suitable means such as a GUI on a display device that may include text, graphics, symbols, or flashing regions of the screen etc. Sounds, flashing lights, vibration, automatically generated and automatically generated phone calls are other notification methods that may be used. Any suitable notification means may be employed.

Alarm module 1326 may include one or more notification rules useful for determining what contacts to notify with specific alarm information and under what circumstances to do so. Alarm module 1326 may also access a database of contact information in data store 1104 when a rule is triggered indicating a specific contact who is to receive specific alarm information for a given alert. Alarm module 1326 may communicate the information using any suitable method such as by e-mail, by automated telephone call, by a Short Message Service (SMS) “text” message, by a push notification to an app on a personal computing device such as a cell phone, smart watch, or tablet and the like.

In another aspect, alarm module 1326 may be configured to maintain information about alarm rules used by alarm module 1226 in patient monitoring device 1108. Alarm module 1326 may be configured to accept input from computer 1106, or elsewhere, adjusting how and when the rules trigger alarms based on the various parameters in a patient profile 1244. These rule upgrades may then be sent to a specific patient monitoring device 1108, or to all such patient monitoring devices thus allowing the behavior of the monitoring devices to be upgraded and improved.

A communication module 1322 may be included in server 1102. Communication module 1322 may operate like communication module 1234 in patient monitoring device 1108. Module 1322 may be configured to open and maintain communication links to various other parts of the patient monitoring system such as server data store 1104, patient monitoring device 1108 and others. Communication module 1322 may be configured to implement any suitable digital, analog, or other communication scheme using any suitable 15 networking, control, or communication protocol. Communication module 1322 may engage or use networking module 1312 to manage communication with other aspects of the patient monitoring system via network 1110 and any communications links that may be involved.

Location finding module 1324 may be included and may configure server 1102 to collect, analyze, process, and/or maintain information in real time indicating the location of patients, caregivers, or other people and objects. Such location information may be used by the system in order to route alert information to the proper caregivers. For example, alarm module 1326 may collaborate with location finding module 1324 and use patient and caregiver contact information from data store 1104 to determine the closest qualified caregiver to notify when an alarm is issued. Location finding module may use any suitable technology whether internal or external to the patient monitoring system for tracking the location of people and objects such as Global Positioning System (GPS) and/or Real-Time Location System (RTLS), and the like.

Software 1304 may include heuristics module 1318 which may configure server 1102 to make adjustments to patient profiles based on input from caregivers, past events or alarms, ongoing monitoring of events as they occur, and the like. Adjustments to patient profiles may be made based on past information to better anticipate or predict situations where an alarm should be issued more often, least often, or not at all. Server 1102 may process this information substantially continuously during normal operation as new data is collected from patient monitoring devices, and as alerts are raised and feedback from caregivers is received.

In one example, heuristics module 1318 may send variable profile updates for one or more patient profiles if multiple false positives, or false negatives are encountered during treatment. For example, patient monitoring device 1108 may sense motion or pressure relative to a support surface that falls outside parameters in the patient's profile causing an alarm message to be sent. After observing the patient, a caregiver may determine that the alert was a false indication of a potential patient fall when the likelihood of a fall was actually very low (i.e. below a predetermined threshold). Heuristics module 1318 may receive this information from a computer 1106 which may include data collected at the time of the event. Heuristics module 1318 may then analyze the data and adjust parameters in the patient's profile accordingly to reduce or eliminate the number of similar future false alarms for that particular patient, and possibly for all other similarly situated patients. These adjustments to other patient monitoring devices may occur in real time as soon as the data can be analyzed after the alert has been handled by caregivers.

In another example, the heuristics module 1318 may be used to calculate thresholds for one or more standard or default profiles based on patient and demographic data and “pre-alarm” or other information available for an alarm event. The heuristic module may, over time, collect a large body of sensor data, event data, alarm information, demographic information, and the like which may be used to refine thresholds in patient profiles or in default profiles, to better align the parameters that may generate an alert with the patient, the patient's history, and the patient's treatment plan.

In another example, the heuristics module may be used to determine that changes to the functional aspects of alarm rules used by alarm module 1226 in patient monitoring device 1108 may be beneficial to avoid excessive false alarms. Heuristics module 1318 may determine from analyzing alarm data over time that certain alarm rules are causing excessive false readings and should be reviewed and/or removed from alarm module 1226.

A patient profile generator module 1320 may be included for creating patient profiles that may be used by other devices in the system such as patient monitoring device 1108. Profile generation module 1320 may create the profile, and deliver it to a patient monitoring device 1108 via communications links 1112 and 1118, and network 1110.

Profile generator 1320 may be used when the system begins monitoring a patient, or at any other suitable time such as when a new profile is needed for any reason. An “initial” or “default” profile may be selected initially to provide a template or baseline profile that profile generator module 1320 may use in tailoring the profile to the patient. The system may include multiple “default” profiles specific to any number of parameters or aspects. For example, the system may have separate default profiles for men, for women, or multiple profiles for men and women specific to various age ranges, races, medical histories, drug therapies, and the like. Any patient data may be considered in selecting and generating a profile such as data about any medical conditions a patient may have that may be detected by the patient monitoring device.

For example, a person with a neuromuscular disorder, or other disorder, that causes regular periodic movement of an arm, leg, or neck may benefit from an initial profile with parameter threshold values that take this kind of movement into consideration. These threshold values may thus configure patient monitoring device 1108 to adjust its threshold values to account for movement specific to the patient's particular condition so that extraneous movements common to people with the patient's condition are ignored

Profile generation module 1320 may also configure server 1102 to accept input selecting an appropriate “default” profile, and additional input from a caregiver using server 1102 or another computer such as computer 1106 to tailor the profile to a particular patient's specific needs. Customizing the profile may include importing or entering aspects of a patient's treatment plan, or entering details specific to the patient's condition that are not provided in the default profile, or differ from the threshold settings provided by the default profile.

FIG. 4 illustrates at 1400 one example of a data store or knowledge base 1104 that may be part of the patient monitoring system to store information. Data store 1104 may be included as part of the data storage and analytics system 110, or vice versa. In another aspect, the data store 1104 and the analytics system 110 may be separate storage systems that may optionally communicate with one another to detect potentially adverse patient activity and to then raise alerts to nearby badges.

Though the patient's identity need not be revealed, data store 1104 may include patient data 1408 having patient records with detailed information about the patient's medical history, treatment plan, demographics, and the like. Sensor data 1406 may be included for storing various pressure, motion, proximity, and other data collected or processed by patient monitoring devices 1108. Data store 1104 may include event data 1404 with detailed information captured by patient monitoring device 1108, server 1102, and computers 1106 when an event occurs. Event data may include or refer to other information such as sensor data 1406, patient data 1408, as well as information about the decision making process leading up to the event being created and sent. For example, event data 1404 may include the sequence and selection of rules that were triggered causing the event to be sent. It may include other data such as a patient's vital signs before, during and after the event, which caregivers responded, how long it took them, how far they had to come to lend aid, and the like.

Data store 1104 may also include contact information that can be used by the patient monitoring system to contact information for various individuals or other devices/systems that can have notification information sent to them. Contact information in the contact database 1354 may include names, addresses, email addresses, telephone numbers, Internet Protocol (IP) addresses, web service URLs, or any other suitable information useful for contacting an entity interested in receiving event notification information. Server 1106 may receive and process events from multiple monitoring devices 1108. Once processed, the notification information may be sent to contacts specified in contact database 1410. These contacts may receive the notification information for one or more events using a personal or mobile computer 1106.

A computer or other electronic alert device like computer 1106 may be used by caregivers to receive alert information from server 1102 or personal monitoring devices 1108. Such a computer, or similar alert device, may also be used in proximity to a patient, such as in the patient's room, or worn as an arm band to notify the patient that their movements may lead to a fall.

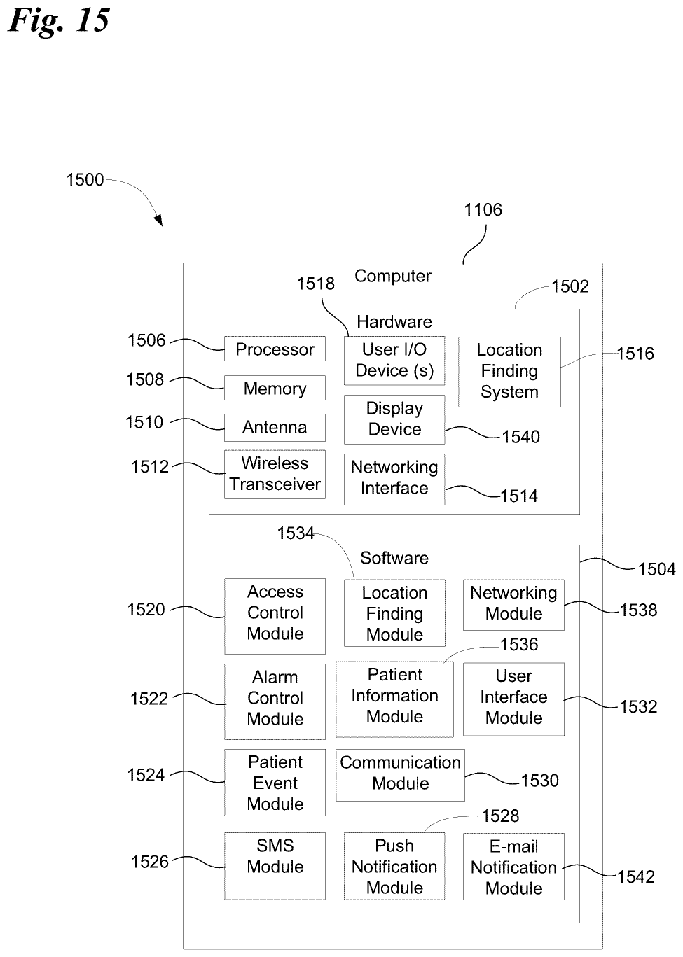

One example of the software and hardware aspects that may be included in computer 1106 is illustrated in FIG. 15 at 1500. As noted above, a badge of the present disclosure is an example of a computer 1106, and therefore may optionally include some or all of the components shown at 1500. These components at 1500 may be alternatives to, or provided in addition to, components illustrated in FIG. 10 at 1000.

Hardware 1502 included in computer 1106 may be configured according to instructions included in software 1504 controlling the computer to receive alarm information, make the information in the alarm available to a user such as a caregiver, and allow the caregiver to respond accordingly in a timely fashion.

Hardware 1502 may include a processor 1506 which may be programmed to perform various tasks discussed herein related to monitoring patient activity. Processor 1506 may be coupled to any other aspects of hardware 1502 such as memory 1508, networking interface 1514, and others. The functions performed by processor 1506 may be configured according to instructions encoded in software 1504, or in hardware 1502.

Computer 1106 may include user I/O devices 1518 which may include hardware and/or related software for managing input and output with devices 1518. These devices may include equipment such as keyboards, mice, touchscreens, intelligent voice recognition and the like. A network interface 1514 may be configured to interact with networks like network 1110 via communications links like links 1112, 1114, 1116, and/or 1118. A display device 1540 may be included as well for displaying a user interface generated by computer 1106. With many tablet, smart phone, smart watch, or desktop personal computing devices, display device 1540 may be a touchscreen making it part of the user I/O equipment 1518 as well.

A memory 1508 may be included as well for temporarily or permanently storing data values or instructions and the like. Computer 1106 may also include a wireless transceiver 1512 which may include hardware and/or software implementing a wireless communication interface. Wireless transceiver 1512 may be coupled to an antenna 1510, and may include a transmitter, receiver, and/or other useful equipment configured to send and receive signals. In this respect, wireless transceiver 1512 may be useful for maintaining a wireless communication link such as link 1116 and may interact with network interface 1514 as necessary to receive and send information. Wireless transceiver 1514 may also be useful for sending and receiving cellular telephone calls such as telephone calls, text messages, and the like.

Hardware 1502 may also include a location finding system 1516 that may use any suitable technique for obtaining a physical location for computer 1106. The location-finding system may use any combination of other hardware and software to accomplish the goal of maintaining accurate and precise positional information. Wireless transceiver 1512 and antenna 1510 may be used to triangulate the position of computer 1106 based on communications with various transmitters and receivers in the area.

For example, location finding system 1516 may determine the location of computer 1106 based on communications with beacon transmitters and/or networked receivers positioned in known locations around the environment to be monitored. These transmitters and receivers may be included in networking equipment operating as part of a local wireless network that conforms to Institute of Electrical and Electronics Engineers (IEEE) 802.11 wireless networking standards (sometimes referred to as a “WiFi” or a Wireless Local Area Network or “WLAN”). In another example, these transmitters and/or receivers positioned in the environment may include devices that operate according to the IEE6802.15 wireless networking standards (sometimes referred to as a “Bluetooth” or Wireless Personal Area Network or “WPAN”). Other technologies may be useful as well as the satellite based Global Positioning System (GPS) or triangulation based on interactions with cell tower transmitters and receivers that are part of a cellular network.

Software 1504 may include various modules for configuring functional aspects of computer 1106. A user interface module 1532 may be provided for generating user interfaces with graphical buttons, windows, text boxes, selection boxes, and other widgets configured to gather data or elicit specific responses from the user which may be accessible using any suitable input device such as a touch screen, mouse, or keyboard. User interface module 1532 may also display various glyphs, figures, icons, graphs, charts, tabular displays, and the like which may or may not be modified or interacted with using any suitable input device. User interface module 1532 may be used in conjunction with other software modules to provide navigational control between various presentations of information, to accept character or selection input from an input device, and/or to generate graphical displays of relevant data accessed by other software modules. User interface module 1532 may operate in conjunction with an operating system installed on computer 1106 which may include libraries of windowing widgets, basic input/output capabilities, and basic file system and network interfaces for user interface module 1532 and for other software modules as well.

User interface module 1532 may use any suitable display technology, programing language, toolkit, Application Program Interface (API), or protocol to create the user interfaces for computer 1106. Module 1532 may, for example, interpret and display a dynamically or statically created web page sent from server 1102 as Hypertext Markup Language (HTML) and may include a web browser for viewing the results. User interface module 1532 may include an “app” or application operating as a client and connecting to server 1102 over network 1110 to retrieve data which is then displayed using graphical controls such as buttons, selection boxes, text fields, widgets, and the like.

In one example, user interface module 1532 may include a graphical user interface displaying alert information. This information may include an indication of the severity of the alert, the patient's name and/or location, an indication of the type of alert (e.g. a fall, change in position, excessive movement, etc.), and/or any other relevant information made available by a patient monitoring device or any other part of the monitoring system. A map of the local area may be included as well with indicia showing the patient's location in relation to the location of computer 1106. In another example, the alert information may be configured to exclude information identifying the patient. In yet another example, noise may be included in the data from the monitoring device to further obscure a specific patient's identity.

Multiple response options may be presented by user interface module 1532. A responding individual may select buttons, checkboxes, enter text, or perform other actions based on the options provided. For example, computer 1106 may be a tablet computer, smart watch, or smartphone which may be carried by a responder to the patient's location. Upon inspecting the patient and the circumstances surrounding the alarm, a responder may use the options presented by user interface module 1532 to notify the patient monitoring system that a visual or other inspection of the patient, the patient's equipment or environment was performed. The user interface provided may configure computer 1106 to accept input indicating the alert was warranted and was due to patient movement or other activity that was potentially detrimental. The user interface may be configured to accept input indicating the alarm was not warranted and was due to, for example, an equipment malfunction or resulted from harmless or unintentional patient activity (e.g. mistakenly or incidentally bumping the sensor while asleep, or otherwise triggering the alarm through harmless action). This information may then be passed to server 1102, data store 1104, or to any other aspect of the patient monitoring system.

An access control module 1520 may be included for identifying the user of computer 1106 according to one or more credentials and for controlling access to hardware and software aspects of the system. Such access control may include a user interface generated by user interface module 1532 which may include buttons, text fields, and other controls configured to accept credentials as input from a user. Such credentials may include a user name, password, answers to questions, and the like. Other examples may include credentials stored on a physical object in the possession of the user, such as a Radio Frequency Identification (RFID) tag, Near Field Communication (NFC) badge, card with magnetic strip, barcode, portable memory device (e.g. Universal Serial Bus (USB) memory “stick” or plastic card) containing a secret token or other encoded or encrypted information.

In another example, user credentials may include biometric input. Access control module 1520 may control a biometric input device which may be one of user I/O devices 1518. This device may be configured to measure or scan or accept data representing one or more physical characteristics of the user such as a fingerprint, handprint, iris, facial topography, word, phrase, or other vocalization, and the like.

A location finding module 1534 may be included and may configure computer 1106 to process information received by location finding system 1516 to determine the location of computer 1106. This location information may be used by the system in order to route alarm information to the proper caregivers. Location finding module may also send the location information to other parts of the system such as server 1102. This information may be distributed continuously and/or at regular intervals and may be used to determine the location of the closest qualified caregiver when an alarm is raised.

An SMS module 1526 may be included with software 1504 for configuring computer 1106 to receive text messages distributed by server 1106, or by others. SMS module 1526 may configure computer 1106 to interact with other servers such as SMS service centers or short message gateways to receive the SMS messages specific to a particular personal computing devices 1302. SMS module 1526 may interact with other modules such as user interface module 1532 to display SMS messages according to user preferences.

A push notification module 1528 may be included with software for configuring computer 1106 to receive push notification messages distributed by server 1102, or by others. Push notification module 1528 may configure computer 1106 to interact with centralized push notification servers using network interface 1514, communications link 1116, or other suitable communications links. Push notification module 1528 may interact with other modules such as user interface module 1532 to display push notifications according to user preferences. Push notification module 1528 may be configured to send and/or receive push notifications according to any suitable protocol. Examples include, but are not limited to, Advanced Message Queuing Protocol (AMQP), Message Queue Telemetry Transport (MQTT) protocol, and Simple/Streaming Text Oriented Messaging Protocol (STOMP).

An e-mail module 1542 may be included with software for configuring computer 1106 to receive email messages distributed by server 1106, or by others. Email module 1542 may configure computer 1106 to interact with centralized electronic mail servers using network interface 1514, communications link 1116, or other suitable communications links. Email module 1542 may interact with other modules such as user interface module 1532 to display email messages as specified by the user.

Software 1504 may include an alarm control module 1522 which may be included to configure computer 1106 to receive alarm related messages, events, or data from other devices in the patient monitoring system 1100 such as server 1102. Alarm control module 1522 may use other hardware or software modules to display and otherwise alert the patient or a caregiver that an alarm has been raised. Alarm control module may be configured according to user preferences, or according to a predetermined notification policy, to display any combination of visual, audible, haptic, tactile, or other notification of an alarm. Such notification may include a push notification appearing on a display device 1540, an e-mail sent to a caregiver's e-mail address, an SMS message viewable using SMS module 1526 or other SMS client software in computer 1106, an automatic telephone call, an alarm indicia appear on display device 1540 using user interface module 1532, and/or an audible sound or ringtone being played, or any suitable combination thereof.

Alarm control module 1522 may display details about the patient involved in the alert by accessing patient information using patient information module 1536, and/or by accessing patient data 1408 in data store 1104. Information about the patient, the alarm, and other related information may also be included in the alarm message sent from server 1102. Alarm control module 1522 may collaborate with user interface module 1532 to display this information to the caregiver allowing them to view specifics about the event, or activities that lead up to the event. This user interface may be configured to accept input from a user that may include response options such as confirming the alarm is valid, declaring that it is invalid, making adjustments to the profile thresholds thus changing the behavior of patient monitoring device 1108, and/or entering additional observations about the patient, the equipment, the treatment plan, and the like.

Networking module 1538 may include software for configuring computer 1106 to establish and maintain communication link 1364. Networking module 1538 may therefore configure processor 1506, network interface 1514, DO devices 1518, and any other suitable hardware or software in compute 1106. Any suitable protocols may be supported by networking module 1538 such as Transmission Control Protocol/Internet Protocol (TCP/IP), User Datagram Protocol (UDP). Ethernet protocol, or any other suitable networking protocol. Any of these protocols may be used to establish and maintain communications link 1116 which may then be used to interact with server 1106. Put another way, server 1106 may use any of these protocols, or any other suitable networking protocol to distribute information to computers 1106, or to other recipient systems.

A communication module 1530 may be included in computer 1106. Communication module 1530 may operate like communication modules 1234 and 1322 in patient monitoring device 1108 and server 1102 respectively. Module 1530 may be configured to open and maintain communication links to various other parts of the patient monitoring system such as server data store 1104, patient monitoring device 1108 and others. Communication module 1322 may be configured to implement any suitable digital, analog, or other communication scheme using any suitable networking, or control protocol.

A patient event module 1524 may be included in software 1504 which may configure computer 1106 to process information about activities or events taking place with monitored patients. These events may be sent by server 1102 or patient monitoring device 1108, and may or may not involve emergency or alarm situations. As discussed above, patient events may be generated by patient monitoring device 1108 and distributed by server 1102. These may include notifications about a patient's movements, changes in position, and the like. Event module 1524 may be configured to receive these and other events, and make them available to a caregiver. A caregiver may view this information when an alarm is raised, or at other times to better ensure patient safety and adherence to prescribed treatment plans.

A patient information module 1536 may be included with software for configuring computer 1106 to obtain and display patient information. Patient information module 1536 may configure computer 1106 to interact with a centralized database of patient information such as data store 1104 to obtain information for review, to edit information in the data store, to add new patient information, or to delete information that is incorrect or extraneous. Patient information module may interact with other modules such as user interface module 1532 to display patient information messages upon request by a user, or with alarm control module 1522 to obtain and display patient information or links which display patient information if selected by the user.

An example of the patient monitoring system in operation is illustrated in FIGS. 6 and 7 at 1600 and 1700 respectively. At 1602, the patient profile is initialized. This may be performed by a caregiver using a computer 1106 interacting with server 1102 and data store 1104. For example, computer 1106 may display an access control interface created by user interface module 1532 and/or access control module 1520. A user's access control credentials may be provided and authenticated against contact information 1410 in data store 1104.

An initial portion of patient information may be retrieved using patient information module 1536 and user interface module 1532 may display this information in a profile generation or initialization interface. The profile initialization interface may also be configured to accept input from a user allowing the user to select a default profile based on default profile options provided by patient profile generator module 1320 in server 1102. A user may provide input selecting a profile and making any adjustments to the default values for the profile parameters to match the parameters to that specific patient and the patient's treatment plan. When ready, the patient profile may be saved to patient data 1408 in data store 1104, and sent to a patient monitoring device 1108.

At 1604, the patient monitoring device with the patient's profile may be activated and “installed” or placed in an appropriate location to monitor the patient's activities. Such appropriate locations include any location suitable for monitoring patient activity such as on or adjacent a patient's head, neck, torso, foot, arm, leg or other area. The monitoring device, or parts thereof, may be installed in a bed, chair, or other supporting structure instead of, or in addition to being mounted on the patient. In one example, the monitoring device may be worn by the patient, and at least one of the sensors may be included in the patient's clothing such as in a sock or gown worn by the patient. It may be advantageous to position the monitoring device, or any of the sensors associated with it, on a patient's extremity such as in a sock worn on a foot, in an armband worn on the wrist, or on the head, knee, or elbow to name a few other non-limiting examples. Such a position can result in more noticeable changes in position that may be used to more accurately predict when a patient is making movements that may result in a fall.

When activated, the patient monitoring device 1108 may begin obtaining sensor output at 1606, and comparing the sensor output to the profile parameters at 1608. If the output is within the limits of the parameters at 1610, the monitoring device continues monitoring sensor readings taken at 1606. These sensor readings may be sent to server 1102 and saved to data store 1104. Server 1102 may transmit the readings to a computer 1106 periodically or continuously, or all computers 1106 who are configured to retrieve them.

When the output for a sensor falls outside the threshold values defined by the parameters in the patient profile, an alert may be triggered at 1612. The alert may be sent from alarm module 1226 and received by server 1102. Server alarm module 1326 may process the alert as discussed above, sending it to the appropriate caregiver's computer 1106. User interface module 1532 may then display details about the alarm to the respective caregiver(s). If the alarm is confirmed to be valid at 1614, the caregiver may provide input to that effect using computer 1106. If the alarm is confirmed to be false at 1618, the caregiver may acknowledge this as well using computer 1106. The system may update the historical sensor and event related data at 1620 allowing heuristic module 1318 to refine profile parameter settings for future profiles to improve and refine the system's overall knowledge of patient behavior, and/or to better avoid false alarms in the future. Whether the alarm is valid or not, user interface module 1532 may provide a caregiver with a profile interface for adjusting a patient's profile parameters. Such adjustments may be made by sending the updated profile to server 1102 and monitoring device 1108 at 1622 and the monitoring activities may continue at 1606.

One example of the kinds of comparisons the system makes between the sensor output and the profile parameters in the patient profile is illustrated at 1700 in FIG. 7. At 1702, the motion sensor in the monitoring device includes an accelerometer. The monitoring device operates in a “low power” or “stand-by” mode monitoring data from the accelerometer to detect movement of the patient which is greater than or equal to a predefined activation threshold. In stand-by mode, the monitoring device may disable other sensors such as gyroscope sensors, pressure sensors, proximity sensors, and the like. The monitoring device may also disable wireless transceivers, network interfaces or other modules that may consume additional power. In this example, as long as the accelerometer activity is less than the activation threshold at 1704, the monitoring device maintains the “stand-by” operating mode.

When the accelerometer indicates patient movement that exceeds the activation threshold, the monitoring device moves from “stand-by” mode to “full monitoring” mode at 1706. In this mode, additional modules, subsystems, or other aspects of the monitoring device may be enabled. Examples include a network interface may be enabled to allow an alert to be transmitted over the network 1110. Other sensors may also be enabled at 1708 such as one or more pressure sensors, gyroscopic sensors, proximity sensors, and/or temperatures sensors. By disabling these sensors in “stand-by” mode, the monitoring device can conserve power. If pressure, gyroscope, temperature, or other sensor data exceeds thresholds in the patient profile at 1710, the alert is triggered at 1612. Alternatively, the monitoring device may be configured to trigger an alert when the accelerometer data alone has exceeded the threshold.

The pressure sensor may be in a sock worn by the patient, and the pressure sensor may generate a signal that is a time-varying voltage corresponding to the level of pressure the patient is exerting on the sensor. For example, when laying in bed, sitting in a chair, or in some other resting position where pressure is at or near a minimal value, the signal may be less than 800 mV. When the signal is at or near a maximum value for a given patient, such as when the patient is standing, the signal may be over 11800 mV. These values may be tailored specific to a particular patient. For example, a lighter patient, such as a child, may not be heavy enough to generate 11800 mV. Therefore, the profile thresholds may be adjusted accordingly by the server when the profile is initially loaded into the monitoring device, or later by the caregiver using a computer 1106 to adjust the values as needed.

The monitoring device may be programmed to perform more complex analysis of the signal data received from the various sensors. Different constant values may be also applied to the sensor data to effectively “weight” certain sensor data, or combinations of sensor data more heavily than others. In one example, the monitoring device samples the signals from motion sensors such as an accelerometer and a gyroscope, as well as signals from a pressure sensor. The data collected for each sample from each sensor may include a single value, or multiple values such as a value for three separate planes orthogonal to one another (e.g. “up/down”, “left/right”, and “forward/backward”). The values may be combined according to a particular function to calculate a result that may be compared with an alert threshold to determine when the alert threshold has been met or exceeded and a caregiver should be notified.

In one example, the sensors may yield three individual overall acceleration, pressure, and angular moment values for each of n evenly spaced samples at separate times t. These individual values may be weighted using constants C₁, C₂, and C₃, as follows:

$$y ( t ) = {C}_{1} a + {C}_{2} g + {C}_{3} p$$

where;
   t is the time the sample is taken
   α is the value from the accelerometer at time t
   g is the value from the gyroscope at time t
   p is the value from the pressure sensor at a time t

In another example, the sensors may yield seven separate values at each time t, six of which represent acceleration α and angular momentum g measured at time r in each of three corresponding directions that are orthogonal to one another (e.g. “up/down”, “left/right”, and “forward/backward”). The remaining value may be a pressure measurement p measuring pressure exerted by a patient's foot. The data collected might appear as follows:
3-axis Accelerometer data: αₓ, α_{y}, α_{z}
3-axis Gyroscope data: g_{α}, g_{β}, g_{γ}
Pressure data: p

An equation combining these values might then be:

$$y ( t ) = {C}_{1} {a}_{x} + {C}_{2} {a}_{y} + {C}_{3} {a}_{z} + {C}_{4} {g}_{α} + {C}_{5} {g}_{β} + {C}_{6} {g}_{γ} + {C}_{7} p$$

where:
   t is the time the sample is taken
   αₓ, α_{y}, α_{z}, is the value from the accelerometer in the plane x, y, and z respectively at time t
   g_{α}, g_{β}, g_{γ}, is the value from the gyroscope in the plane a, B, and y respectively at time t
   p is the value from the pressure sensor at a time t

In another example, the sensors may yield nine separate values at each time t representing acceleration α, angular momentum g, and pressure measurement p taken at a time t in each of three corresponding directions that are orthogonal to one another. The data collected may then be as follows:
3-axis Accelerometer data: αₓ, α_{y}, α_{z}
3-axis Gyroscope data: g_{α}, g_{β}, g_{γ}
3-axis Pressure data: p_{α}, p_{b}, p_{c}

From these data values, a more sophisticated function may be constructed employing many constants C which may be used to apply a more granular weighting to the data from the sensors, or to any permutation or combination of the data. One example of such a function is:

$$y ( t ) = {C}_{1} {a}_{x} + {C}_{2} {a}_{y} + {C}_{3} {a}_{z} + {C}_{4} {a}_{x} {a}_{y} + {C}_{5} {a}_{x} {a}_{z} + {C}_{6} {a}_{y} {a}_{z} + {C}_{7} {a}_{x} {a}_{y} {a}_{z} + {C}_{8} {g}_{α} + {C}_{9} {g}_{β} + {C}_{10} {g}_{γ} + {C}_{11} {g}_{α} {g}_{β} + {C}_{12} {g}_{α} {g}_{γ} + {C}_{13} {g}_{β} {g}_{γ} + {C}_{14} {g}_{α} {g}_{β} {g}_{γ} + {C}_{15} {p}_{a} + {C}_{16} {p}_{b} + {C}_{17} {p}_{c} + {C}_{18} {p}_{a} {p}_{b} + {C}_{19} {p}_{a} {p}_{b} + {C}_{20} {p}_{b} {p}_{c} + {C}_{21} {p}_{a} {p}_{b} {p}_{c}$$

Constants C₁ through 4₂₁ can be determined initially by experimentation and analysis to yield an appropriate single value y(t) for any give sampling to predict or report when patient movement exceeds the predetermined thresholds. These constants may be adjusted over time either automatically by the system or by a caregiver to refine when the system reports a “stand” or “fall” event to avoid false readings.

The concepts illustrated and disclosed herein may be arranged and configured according to any of the following non-limiting numbered examples:
Example 1: A device, comprising:
   a display device; and
   a control circuit.
Example 2: The device of any preceding claim, wherein the control circuitry is arranged and configured to implement features disclosed herein.
Example 3: The device of any preceding example, comprising:
   a memory, a processor, input/output devices, networking components, and/or a battery, and any combination thereof.
Example 4: The device of any preceding example, comprising:
   an SoC module that optionally includes one or more integrated antennae.
Example 5: The device of any preceding example, comprising:
   one or more sensors configured to detect aspects of the environment, or of any specific sense parameter including, but not limited to acceleration, temperature, humidity, heart rate, blood pressure, altitude, movement, orientation with respect to gravity, sound, vibration or any combination thereof.
Example 6: The device of any preceding example, comprising:
   hardware and/or software implementing one or more wireless communication interfaces.
Example 7: The device of any preceding example, comprising:
   hardware and/or software implementing a Bluetooth or Bluetooth Low Energy (BLE) protocol, hardware and/or software implementing a Wi-Fi protocol, hardware and/or software implementing a Low Power Wide Area protocol such as LoRa or LoRaWAN, hardware and/or software implementing a Global Position System (GPS) interface to determine the geographic location of the badge, hardware and/or software implementing a cellular data communications such as 3G/4G/LTE/5G and the like for establishing remote communications or determining geographic location via a cellular network, or any combination thereof.
Example 8: The device of any preceding example, comprising:
   hardware or software implementing the capability for over-the-air (OTA) updates such as Bluetooth.
Example 9: The device of any preceding example, comprising:
   one or more light emitting diodes (LEDs)
Example 10: The device of any preceding example, comprising:
   one or more LEDs configured to emit multiple programmable combinations of red, green, blue (RGB) light to provide for a range of colors or combinations thereof
Example 11: The device of any preceding example, wherein the device is programmed or configured to generate different color arrangements or patterns of flashing lamps to indicate different alert statuses.
Example 12: The device of any preceding example, comprising a Pulse Width Modulation (PWM) driver for to control frequency of activation of LEDs of the device and perceived intensity and/or color where multiple colored LEDs are included.
Example 13: The device of any preceding example, wherein the display device includes an LED screen, an e-ink screen or any combination thereof.
Example 14: The device of any preceding example, wherein the display includes backlighting lamps, or wherein the display is free of backlighting lamps.
Example 15: The device of any preceding example, wherein the display is optionally touch or pressure sensitive
Example 16: The device of any preceding example, comprising:
   a device for causing vibration; and/or
   a device for generating audible noise.
Example 17: The device of any preceding example, comprising:
   an internal power source such as a battery arranged and configured to provide power to the badge and some or all of the components thereof.
Example 18: The device of any preceding example, wherein the battery is optionally configured to provide sufficient power to operate the device for at least 12 hours.
Example 19: The device of any preceding example, wherein the device is water resistant to the I1665 standard.
Example 20: The device of any preceding example, comprising:
   a control circuit with a system-on-chip (SoC) architecture with one, two, three, or more, processor cores:
      a first core for user applications.
      a second core for Wi-Fi 802.11a/b/g/n.
      a third core for Bluetooth low energy (BLE).
   an ARM processor for secure boot.
   a supervisor chip to hold the processor in the reset state during power up.
Example 21: The device of any preceding example, comprising:
   a synchronous, multi-master, multi-slave, packet switched, single-ended, serial communication bus;
   a Serial Peripheral Interface (SPI);
   a Quad Serial Peripheral Interface (QSPI);
   an Universal Asynchronous Receiver/Transmitter (UART) interface;
   a Pulsed Width Modulation (PWM) module;
   a General Purpose Input/Output (GPIO) module;
   an Analog to Digital Converter (ADC) or Digital to Analog Converter (DAC) module, or any combination thereof.
Example 22: The device of any preceding example, wherein the device is configured to send and receive images to be displayed on the display device.
Example 23: The device of any preceding example, comprising nonvolatile memory for storing an image.
Example 24: The device of any preceding example, comprising:
   a momentary switch for providing input to the device from a user;
Example 25: The device of any preceding example, comprising:
   terminals for receiving power to charge a battery of the device, the terminals being wired or wireless.
Example 26: The device of any preceding example, wherein the device is configured to provide patient status information including, patient fall risk information, patient biometric information, patient location information or any combination thereof.
Example 17: The device of any preceding example, wherein the device is configured to provide location information to a remote server.
Example 28: The device of any preceding example, wherein the device is configured to display an alert message using the display device.
Example 29: The device of any preceding example, wherein the device is configured to display a photo and/or occupation information for a user of the device.
Example 26: The device of any preceding example, wherein the device is configured to accept input triggering an alert from the device.
Example 17: A system, comprising:
   a wearable computing device (or “badge”), responsive to one or more other computing devices;
   a management server;
   a security system;
   location finding system.
Example 28: A system, comprising:
   a local computer, responsive to the badge and configured to accept input or provide output in collaboration with the badge.
Example 29: A system, of any preceding system example, wherein the management server is configured or programmed to manage badges and badge interaction.
Example 30: A system, of any preceding system example, wherein the management server is configured
   to collect location information from badges.
Example 31: A system, of any preceding system example, wherein the management server is configured to triangulate location of one or more, or all, badges in real time to maintain situational awareness of physical location of the badge(s) on the earth.
Example 32: A system, of any preceding system example, wherein the management server is configured to automatically clear alerts or warnings when a badge passes to within a predetermined threshold distance from a predetermined point.
Example 33: A system, of any preceding system example, wherein the management server is configured to notify badges of an alert including signaling one or more badges to generate an audible alarm, visual alarm, change image on the screen of the badge, or any combination thereof
Example 34: A system, of any preceding system example, wherein the management server is configured to define, and/or accept input defining, multiple zones.
Example 35: A system, of any preceding system example, wherein the management server defines a zone as a single floor of a building, a group of floors in a building, multiple separate buildings, multiple buildings or facilities across town, or around the world, or any combination thereof.
Example 36: A system, of any preceding system example, wherein the management server is configured to escalate alerts if no badges respond to an alert, or if an alert condition is not cleared before a predetermined timeout, or if not enough resources respond.
Example 38: A system, of any preceding system example, wherein the management server is configured to automatically alert more badges to come within a predetermined distance of the alert source as the escalation level increases. For example, the system may require 1 badge for initial response, three or more for next level, five or more for the next level, etc. as the escalation level becomes larger, the number of badges required to respond my also increase.
Example 39: A system, of any preceding system example, comprising:
   a data storage and analytics server configured or programmed to accept data from other computing devices or badges with information about alerts and the responses achieved.
Example 40: A system, of any preceding system example, wherein the a data analytics server is configured to accept badge usage data from a management server, an access control system, or other sources
Example 41: A system, of any preceding system example, wherein the management server is configured to interact with a badge and a security or access control system to assign the badge to a user.
Example 42: A system, of any preceding system example, comprising:
   a wearable sensing device in communication with the management server;
   wherein the wearable sensing device is configured to alert the management server of an adverse condition or dangerous situation; and
   wherein the management server is configured to alert nearby badges when the dangerous situation is detected.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Activate” generally is synonymous with “providing power to”, or refers to “enabling a specific function” of a circuit or electronic device that already has power.

“And/or” is inclusive here, meaning “and” as well as “or”. For example, “P and/or Q” encompasses, P, Q, and P with Q; and, such “P and/or Q” may include other elements as well.

“Antenna” or “Antenna system” generally refers to an electrical device, or series of devices, in any suitable configuration, that converts electric power into electromagnetic radiation. Such radiation may be either vertically, horizontally, or circularly polarized at any frequency along the electromagnetic spectrum. Antennas transmitting with circular polarity may have either right-handed or left-handed polarization.

In the case of radio waves, an antenna may transmit at frequencies ranging along electromagnetic spectrum from extremely low frequency (ELF) to extremely high frequency (EHF). An antenna or antenna system designed to transmit radio waves may comprise an arrangement of metallic conductors (elements), electrically connected (often through a transmission line) to a receiver or transmitter. An oscillating current of electrons forced through the antenna by a transmitter can create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming electromagnetic wave exert force on the electrons in the antenna elements, causing them to move back and forth, creating oscillating currents in the antenna. These currents can then be detected by receivers and processed to retrieve digital or analog signals or data.

Antennas can be designed to transmit and receive radio waves substantially equally in all horizontal directions (omnidirectional antennas), or preferentially in a particular direction (directional or high gain antennas). In the latter case, an antenna may also include additional elements or surfaces which may or may not have any physical electrical connection to the transmitter or receiver. For example, parasitic elements, parabolic reflectors or horns, and other such non-energized elements serve to direct the radio waves into a beam or other desired radiation pattern. Thus antennas may be configured to exhibit increased or decreased directionality or “gain” by the placement of these various surfaces or elements. High gain antennas can be configured to direct a substantially large portion of the radiated electromagnetic energy in a given direction that may be vertical horizontal or any combination thereof.

Antennas may also be configured to radiate electromagnetic energy within a specific range of vertical angles (i.e. “takeoff angles) relative to the earth in order to focus electromagnetic energy toward an upper layer of the atmosphere such as the ionosphere. By directing electromagnetic energy toward the upper atmosphere at a specific angle, specific skip distances may be achieved at particular times of day by transmitting electromagnetic energy at particular frequencies.

Other examples of antennas include emitters and sensors that convert electrical energy into pulses of electromagnetic energy in the visible or invisible light portion of the electromagnetic spectrum. Examples include light emitting diodes, lasers, and the like that are configured to generate electromagnetic energy at frequencies ranging along the electromagnetic spectrum from far infrared to extreme ultraviolet.

“Battery” generally refers to an electrical energy storage device or storage system including multiple energy storage devices. A battery may include one or more separate electrochemical cells, each converting stored chemical energy into electrical energy by a chemical reaction to generate an electromotive force (or “EMF” measured in Volts). An individual battery cell may have a positive terminal (cathode) with a higher electrical potential, and a negative terminal (anode) that is at a lower electrical potential than the cathode. Any suitable electrochemical cell may be used that employ any suitable chemical process, including galvanic cells, electrolytic cells, fuel cells, flow cells and voltaic piles. When a battery is connected to an external circuit, electrolytes are able to move as ions within the battery, allowing the chemical reactions to be completed at the separate terminals thus delivering energy to the external circuit.

A battery may be a “primary” battery that can produce current immediately upon assembly. Examples of this type include alkaline batteries, nickel oxyhydroxide, lithium-copper, lithium-manganese, lithium-iron, lithium-carbon, lithium-thionyl chloride, mercury oxide, magnesium, zinc-air, zinc-chloride, or zine-carbon batteries. Such batteries are often referred to as “disposable” insofar as they are generally not rechargeable and are discarded or recycled after discharge.

A battery may also be a “secondary” or “rechargeable” battery that can produce little or no current until charged. Examples of this type include lead-acid batteries, valve regulated lead-acid batteries, sealed gel-cell batteries, and various “dry cell” batteries such as nickel-cadmium (NiCd), nickel-zinc (NiZn), nickel metal hydride (NiMH), lithium-ion (Li-ion), or lithium polymer (LiPo) batteries.

“Beacon” or “beacon transmitter” generally refers to a system or apparatus configured to transmit data using electromagnetic energy. The broadcasted data may include any suitable data such as a string of alphanumeric characters uniquely identifying one beacon from others in the environment. Data may appear in a single field in a datagram, or in multiple separate fields. Any suitable protocol may be used to create and transmit the datagrams using any suitable arrangement of fields. The fields may include predetermined numbers of bits according to proprietary or commercially available protocols. One example of a commercially available protocol is the Bluetooth® LE (Low Energy) protocol, also referred to as Bluetooth® Smart protocol.

Datagrams may include one or more fields that may include a preamble, one or more header fields, an access address field, a Cyclical Redundancy Check (CRC) field, a Protocol Data Unit (PDU) field, a Media Access Control (MAC) address field, and a data field. The data field may include an prefix and a proximity Universal Unique Identifier (UUID) which may be configured to distinguish beacons used by one organization from those of another organization. Other data fields may include a major field which may be used to identify multiple beacons as a group, a minor field which may uniquely identify a specific beacon within a group, and a transmission power field which may indicate how far a beacon is from a receiver. The transmitter power field may include one of a set of data values representing distance ranges such as “immediate”, “far”, or “out of range”. A transmission power field may also include more detailed ranging data such as the Received Signal Strength Indication (RSSI) of the beacon at a predetermined range such as 1 meter away. This value may be compared to a current RSSI measured by a receiver and used to calculate an approximate range.

A beacon may include a receiver allowing the beacon to begin broadcasting after receiving a signal from another transmitter. In one example, a beacon may collect energy from the electromagnetic energy directed toward it and may use this energy to transmit its data in response. This type of “passive” beacon may only transmit when energized to do so by some other transmitter. In another example, beacons may have a local power source such as a battery and may transmit continuously and/or at predetermined intervals. In either case, the data sent by the beacon may pass through walls or other objects between the beacon and a receiver making it unnecessary to maintain an unobstructed line of sight between the to.

A beacon may transmit on any suitable frequency or group of frequencies in the electromagnetic spectrum. For example, a beacon may transmit in the Very High Frequency range (VHF), the Ultra High Frequency range (UHF), or in the Super High Frequency range (SHF). Transmissions from a beacon may be directed along a narrow beam by a directional antenna system used by the beacon, or the beacon may use an omnidirectional antenna system configured to broadcast the data in all directions at about the same time.

The data may be programmed in a memory such as a nonvolatile memory in the beacon for repeated transmission at predetermined intervals. For example, transmissions may be repeated up to about every 1500 ms, up to about every 2 seconds, up to about every 30 seconds, or at intervals greater than 30 seconds apart. Beacons may transmit at a very low Transmitter Power Output (TPO) and/or Effective Radiated Power (ERP). TPO or ERP may be less than about 100 milliwatts, less than about 10 milliwatts, or less than about 1 milliwatt.

“Controller” generally refers to a mechanical or electronic device configured to control the behavior of another mechanical or electronic device. A controller may include a “control circuit” configured to provide signals or other electrical impulses that may be received and interpreted by the controlled device to indicate how it should behave.

“Communication Link” generally refers to a connection between two or more communicating entities and may or may not include a communications channel between the communicating entities. The communication between the communicating entities may occur by any suitable means. For example the connection may be implemented as an actual physical link, an electrical link, an electromagnetic link, a logical link, or any other suitable linkage facilitating communication.

In the case of an actual physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Communication node” generally refers to a physical or logical connection point, redistribution point or endpoint along a communication link. A physical network node is generally referred to as an active electronic device attached or coupled to a communication link, either physically, logically, or electromagnetically. A physical node is capable of sending, receiving, or forwarding information over a communication link. A communication node may or may not include a computer, processor, transmitter, receiver, repeater, and/or transmission lines, or any combination thereof.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.

A computer may be a single, physical, computing device such as a desktop computer, a laptop computer, or may be composed of multiple devices of the same type such as a group of servers operating as one device in a networked cluster, or a heterogenous combination of different computing devices operating as one computer and linked together by a communication network. The communication network connected to the computer may also be connected to a wider network such as the internet. Thus a computer may include one or more physical processors or other computing devices or circuitry, and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data). The DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, the “object-relational” model, the “file”, “indexed file” or “flat-file” models, the “hierarchical” model, the “network” model, the “document” model, the “XML” model using some variation of XML, the “entity-attribute-value” model, and others.

Examples of commercially available database management systems include PostgreSQL provided by the PostgreSQL Global Development Group: Microsoft SQL Server provided by the Microsoft Corporation of Redmond, Washington, USA; MySQL and various versions of the Oracle DBMS, often referred to as simply “Oracle” both separately offered by the Oracle Corporation of Redwood City, California, USA; the DBMS generally referred to as “SAP” provided by SAP SE of Walldorf, Germany; and the DB2 DBMS provided by the International Business Machines Corporation (IBM) of Armonk, New York, USA.

The database and the DBMS software may also be referred to collectively as a “database”. Similarly, the term “database” may also collectively refer to the database, the corresponding DBMS software, and a physical computer or collection of computers. Thus the term “database” may refer to the data, software for managing the data, and/or a physical computer that includes some or all of the data and/or the software for managing the data.

“Display device” generally refers to any device capable of being controlled by an electronic circuit or processor to display information in a visual or tactile way. A display device may be configured as an input device taking input from a user or other system (e.g. a touch sensitive computer screen), or as an output device generating visual or tactile information, or the display device may configured to operate as both an input or output device at the same time, or at different times.

The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (one), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometrie modulator display (IMOD), Swept-volume display, Varifocal mirror display, Emissive volume display, Laser display, Holographic display, Light field displays, Volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback on the status of a system, such as the “check engine” light, a “low altitude” warning light, an array of red, yellow, and green indicators configured to indicate a temperature range.

“Electrically connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Electromagnetic Radiation” generally refers to energy radiated by electromagnetic waves. Electromagnetic radiation is produced from other types of energy, and is converted to other types when it is destroyed. Electromagnetic radiation carries this energy as it travels moving away from its source at the speed of light (in a vacuum). Electromagnetic radiation also carries both momentum and angular momentum. These properties may all be imparted to matter with which the electromagnetic radiation interacts as it moves outwardly away from its source.

Electromagnetic radiation changes speed as it passes from one medium to another. When transitioning from one media to the next, the physical properties of the new medium can cause some or all of the radiated energy to be reflected while the remaining energy passes into the new medium. This occurs at every junction between media that electromagnetic radiation encounters as it travels.

The photon is the quantum of the electromagnetic interaction, and is the basic constituent of all forms of electromagnetic radiation. The quantum nature of light becomes more apparent at high frequencies as electromagnetic radiation behaves more like particles and less like waves as its frequency increases.

“Electromagnetic Waves” generally refers to waves having a separate electrical and a magnetic component. The electrical and magnetic components of an electromagnetic wave oscillate in phase and are always separated by a 90 degree angle. Electromagnetic waves can radiate from a source to create electromagnetic radiation capable of passing through a medium or through a vacuum. Electromagnetic waves include waves oscillating at any frequency in the electromagnetic spectrum including, but not limited to radio waves, visible and invisible light, X-rays, and gamma-rays.

“Haptic” generally refers to kinaesthetic communication, “3D touch”, or any technology that can create an experience of touch by applying forces, vibrations, or motions to the user. Haptic devices may incorporate tactile sensors that measure forces exerted by the user on the interface. Examples of haptic feedback devices include an Eccentric Rotating Mass (ERM) actuator, consisting of an unbalanced weight attached to a motor shaft. As the shaft rotates, the spinning of this irregular mass causes the actuator and the attached device to shake. In another example, vibrations may be created using a Linear Resonant Actuator (LRA), which moves a mass in a reciprocal manner by means of a magnetic voice coil, similar to how AC electrical signals are translated into motion in the cone of a loudspeaker. LRAs are capable of quicker response times than ERMs, and thus can transmit more accurate haptic imagery. Other examples include motors configured to manipulate the movements of an item held by the user, or air vortex rings made up of concentrated gusts of air which is an example of a non-contact haptic feedback. In another example, ultrasound beams may be used to created a localized sense of pressure without touching the object generating the ultrasound. Piezoelectric actuators may also be used to produce vibrations, and offer even more precise motion than LRAs, with less noise and in a smaller platform, but may require higher voltages than do ERMs and LRAs

“Input Device” generally refers to any device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.

“Lamp” generally refers to an electrical device configured to produce light using electrical power. The generated light may be in the visible range, ultraviolet, infrared, or other light. Example illumination technologies that may be employed in a lamp include, but are not limited to, incandescent, halogen, LED, fluorescent, carbon arc, xenon are, metal-halide, mercury-vapor, sulfur, neon, sodium-vapor, or others.

“Location Finding System” generally refers to a system that tracks the location of objects or people in real time. Such systems include space based systems like the Global Positioning System (GPS) which may use a receiver on earth in communication with multiple satellite mounted transmitters in space. Such systems may use time and the known position of the satellites to triangulate a position on earth. The satellites may include accurate clocks that are synchronized to each other and to ground clocks. The satellites may be configured to continuously transmit their current time and position. The ground-based receiver may monitor multiple satellites solving equations in real time to determine the precise position of the receiver. Signals from four satellites may be required for a receiver to make the necessary computations.

In another example sometimes referred to as “Real-time Locating Systems” (RTLS), wireless tags are attached to objects or worn by people. Receivers maintained at known, fixed reference points may receive wireless signals from the tags and use signal strength information to determine their location.

The tags may communicate using electromagnetic energy which may include radio frequency (RF) communication, optical, and/or acoustic technology instead of or in addition to RF communication. Tags and fixed reference points can be transmitters, receivers, or both. Location information may or may not include speed, direction, or spatial orientation, and may in some cases be limited to tracking locations of objects within a building or contained area.

Wireless networking equipment may be engaged as well. In one example, known signal strength readings may be taken in different locations serviced by a wireless network such as in 802.11 Wi-Fi network. These known signal strength readings may be used to calculate or triangulate approximate locations by comparing measured signal strength received from a tag against a stored database of Wi-Fi readings or Received Signal Strength Indicators (RSSI). In this way, one or more probable locations may be indicated a virtual map.

In another example, a wireless network transmitter may be configured to send reference signal strength information in packets or datagrams received by the tags. The tags may be configured to measure and/or calculate the actual signal strength of the signal received from the sending transmitter and compare this actual signal strength to reference signal strength information to determine an approximate distance from the transmitter. This distance information may then be sent to other servers or components in the location finding system and used to triangulate a more precise location for a given tag.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO)) variety), Programmable Read Only Memory (PROM), Electronically Programmable Read Only Memory (BPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical dise memory (such as a DVD or CD ROM), a magnetically encoded hard disc or hard disc platter, floppy disc, tape, or cartridge media. The concept of a “memory” includes the use of any suitable storage technology or any combination of storage technologies.

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Motion Sensor” generally refers to a device configured to convert physical movement of an object into an electrical or signal. A motion sensor may be thought of as a transducer detecting physical movement and from it producing a signal (e.g. a time varying signal) based on that movement. A motion sensor may operate by detecting changes in its position relative to other objects by emitting and/or detecting electromagnetic waves. Examples include ultrasonic, infrared, video, microwave, or other such motion detectors.

In another example, a motion sensor may operate by detecting changes in the magnitude and direction of proper acceleration caused by gravity (“g-force”). Sometimes called “accelerometers,” these motion sensors can detect changes in g-forces on an object as a vector quantity, and can be used to sense changes in orientation (e.g. when the direction of weight changes), coordinate acceleration (e.g. when it produces g-force or a change in g-force), vibration, shock, and/or falling in a resistive medium. An accelerometer may thus be used to detect changes in the position, orientation, and movement of a device.

Commercially available accelerometers include piezoelectric, piezoresistive and capacitive components. Piezoelectric accelerometers may rely on piezoceramics (e.g. lead zirconate titanate) or single crystals (e.g. quartz, tourmaline). Piezoresistive accelerometers may be preferred in high shock applications. Capacitive accelerometers may use a silicon micro-machined sensing element.

A motion sensor may include multiple accelerometers. Some accelerometers are designed to be sensitive only in one direction. A motion sensor sensitive to movement in more than one direction may be constructed by integrating two accelerometers perpendicular to one another within a single package. By adding a third device oriented in a plan orthogonal to two other axes, three axes can be measured.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g. 802.11(a). 802.11(b), 802.11(g), or 802.11(n) to name a few). Wireless links may also include or use any cellular network standards used to communicate among mobile devices including 10, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPV6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDEI (Synchronous Digital Elierarchy) protocol. The TCP/IP internet protocol suite may include application layer, transport layer, internet layer (including, e.g., IPv6), or the link layer.

“Of the present disclosure” generally refers to any example of a concept sharing the same or similar name that is included in the chain of priority of the present application, or that is included by reference, if such inclusion is permitted and is applicable. For example, a “badge of the present disclosure” refers to any example of a badge presented herein.

“Optionally” as used herein means discretionary; not required; possible, but not compulsory; left to personal choice.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Personal computing device” generally refers to a computing device configured for use by individual people. Examples include mobile devices such as Personal Digital Assistants (PDAs), tablet computers, wearable computers installed in items worn on the human body such as in eye glasses, watches, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired connection, and/or via other network hardware.

“Portion” means a part of a whole, either separated from or integrated with it.

“Predominately” as used herein is synonymous with greater than 50%.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the X8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER 7 processor manufactured by International Business Machines of White Plains, New York, USA; any of the FX, Phenom, Athlon, Sempron, or Opteron processors manufactured by Advanced Micro Devices of Sunnyvale, California, USA; or the Snapdragon SoC processors manufactured by Qalcomm of San Diego, California, USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.

“Proximity Sensor” generally refers to a sensor configured to generate a signal based on distance to a nearby object, or “target”, generally without requiring physical contact. Lack of mechanical physical contact between the sensor and the sensed object provides the opportunity for extra reliability and long functional life.

A proximity sensor may emit an electromagnetic field or a beam of electromagnetic radiation (e.g. infrared light, for instance), and the sensor may determine proximity based on changes in the field or return signal. The object being sensed is often referred to as the “target” or “sensor target”. Different proximity targets demand different sensors. For example, a capacitive or photoelectric sensor might be suitable for a plastic target; an inductive proximity sensor may require a metallic target.

The maximum distance that a proximity sensor can detect the target is defined as the sensor's “nominal range”. A sensor may begin to emit a signal, or may change the signal already emitted when the distance from the target to the sensor exceeds the nominal range. Some sensors allow for adjustments to the nominal range, or may be configured to return an analog or digital time varying signal based on changes on the distance to the target in time.

“Receive” generally refer system be sent to the monitoring system s to accepting something transferred, communicated, conveyed, relayed, dispatched, or forwarded. The concept may or may not include the act of listening or waiting for something to arrive from a transmitting entity. For example, a transmission may be received without knowledge as to who or what transmitted it. Likewise the transmission may be sent with or without knowledge of who or what is receiving it. To “receive” may include, but is not limited to, the act of capturing or obtaining electromagnetic energy at any suitable frequency in the electromagnetic spectrum. Receiving may occur by sensing electromagnetic radiation. Sensing electromagnetic radiation may involve detecting energy waves moving through or from a medium such as a wire or optical fiber. Receiving includes receiving digital signals which may define various types of analog or binary data such as signals, datagrams, packets and the like.

“Receiver” generally refers to a device configured to receive, for example, digital or analog signals carrying information via electromagnetic energy. A receiver using electromagnetic energy may operate with an antenna or antenna system to intercept electromagnetic waves passing through a medium such as air, a conductor such as a metallic cable, or through glass fibers. A receiver can be a separate piece of electronic equipment, or an electrical circuit within another electronic device. A receiver and a transmitter combined in one unit are called a “transceiver”.

A receiver may use electronic circuits configured to filter or separate one or more desired radio frequency signals from all the other signals received by the antenna, an electronic amplifier to increase the power of the signal for further processing, and circuits configured to demodulate the information received.

Examples of the information received include sound (an audio signal), images (a video signal) or data (a digital signal). Devices that contain radio receivers include television sets, radar equipment, two-way radios, cell phones and other cellular devices, wireless computer networks, GPS navigation devices, radio telescopes, Bluetooth enabled devices, garage door openers, and/or baby monitors.

“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

```
if(clouds.areGrey( ) and
(clouds.numberOfClouds > 100)) then {
  prepare for rain;
} else {
  Prepare for sunshine;
}
```

“Sensor” generally refers to a transducer configured to sense or detect a characteristic of the environment local to the sensor. For example, sensors may be constructed to detect events or changes in quantities or sensed parameters providing a corresponding output, generally as an electrical or electromagnetic signal. A sensor's sensitivity indicates how much the sensor's output changes when the input quantity being measured changes.

“Sense parameter” generally refers to a property of the environment detectable by a sensor. As used herein, sense parameter can be synonymous with an operating condition, environmental factor, sensor parameter, or environmental condition. Sense parameters may include temperature, air pressure, speed, acceleration, the presence or intensity of sound or light or other electromagnetic phenomenon, the strength and/or orientation of a magnetic or electrical field, and the like.

“Signal” generally refers to a function or means of representing information. It may be thought of as the output of a transformation or encoding process. The concept generally includes a change in the state of a medium or carrier that conveys the information. The medium can be any suitable medium such as air, water, electricity, magnetism, or electromagnetic energy such as in the case of radio waves, pulses of visible or invisible light, and the like.

As used herein, a “signal” implies a representation of meaningful information. Arbitrary or random changes in the state of a carrier medium are generally not considered “signals” and may be considered “noise”. For example, arbitrary binary data streams are not considered as signals. On the other hand, analog and digital signals that are representations of analog physical quantities are examples of signals. A signal is commonly not useful without some way to transmit or send the information, and a receiver responsive to the transmitter for receiving the information.

In a communication system, for example, a transmitter encodes a message to a signal, which is carried to a receiver by the communications channel. For example, the words “The time is 12 o'clock” might be the message spoken into a telephone. The telephone transmitter may then convert the sounds into an electrical voltage signal. The signal is transmitted to the receiving telephone by wires, at the receiver it is reconverted into sounds.

Signals may be thought of as “discrete” or “continuous.” Discrete-time signals are often referred to as time series in other fields. Continuous-time signals are often referred to as continuous signals even when the signal functions are not continuous, such as in a square-wave signal.

Another categorization is signals which are “discrete-valued” and “continuous-valued”. Particularly in digital signal processing a digital signal is sometimes defined as a sequence of discrete values, that may or may not be derived from an underlying continuous-valued physical process. In other contexts, digital signals are defined as the continious-time waveform signals in a digital system, representing a bit-stream. In the first case, a signal that is generated by means of a digital modulation method may be considered as converted to an analog signal, while it may be considered as a digital signal in the second case.

“Short Message Service (SMS)” generally refers to a text messaging service component of phone, Web, or mobile communication systems. It uses standardized communications protocols to allow fixed line or mobile phone devices to exchange short text messages. Transmission of short messages between a Short Message Service Center (SMSC) and personal computing device is done whenever using the Mobile Application Part (MAP) of the SS7 protocol. Messages payloads may be limited by the constraints of the signaling protocol to precisely 140 octets (140 octets*8 bits/octet=1120 bits). Short messages can be encoded using a variety of alphabets: the default GSM 7-bit alphabet, the 8-bit data alphabet, and the 16-bit UCS-2 alphabet. Depending on which alphabet the subscriber has configured in the handset, this leads to the maximum individual short message sizes of 160 7-bit characters, 140 8-bit characters, or 70 16-bit characters.

“Transmit” generally refers to causing something to be transferred, communicated, conveyed, relayed, dispatched, or forwarded. The concept may or may not include the act of conveying something from a transmitting entity to a receiving entity. For example, a transmission may be received without knowledge as to who or what transmitted it. Likewise the transmission may be sent with or without knowledge of who or what is receiving it. To “transmit” may include, but is not limited to, the act of sending or broadcasting electromagnetic energy at any suitable frequency in the electromagnetic spectrum. Transmissions may include digital signals which may define various types of binary data such as datagrams, packets and the like. A transmission may also include analog signals.

Information such as a signal provided to the transmitter may be encoded or modulated by the transmitter using various digital or analog circuits. The information may then be transmitted. Examples of such information include sound (an audio signal), images (a video signal) or data (a digital signal). Devices that contain radio transmitters include radar equipment, two-way radios, cell phones and other cellular devices, wireless computer networks and network devices, GPS navigation devices, radio telescopes, Radio Frequency Identification (RFID) chips, Bluetooth enabled devices, and garage door openers.

“Transmitter” generally refers to a device configured to transmit, for example, digital or analog signals carrying information via electromagnetic energy. A transmitter using electromagnetic energy may operate with an antenna or antenna system to produce electromagnetic waves passing through a medium such as air, a conductor such as a metallic cable, or through glass fibers. A transmitter can be a separate piece of electronic equipment, or an electrical circuit within another electronic device. A transmitter and a receiver combined in one unit are called a “transceiver”.

“Triggering a Rule” generally refers to an outcome that follows when all elements of a conditional statement expressed in a rule are satisfied. In this context, a conditional statement may result in either a positive result (all conditions of the rule are satisfied by the data), or a negative result (at least one of the conditions of the rule is not satisfied by the data) when compared to available data. The conditions expressed in the rule are triggered if all conditions are met causing program execution to proceed along a different path than if the rule is not triggered.

“Zone” or “Response Zone” generally refers to a predetermined location, region, or area (a physical definition). Examples of a zone in this context include a specific building, a room, a set of rooms, a group of buildings separated by a few feet, or a few thousand miles, or any distance, a portion of a warehouse, a patient ward in a hospital comprising one or more patient rooms, a floor of a building, and the like.

In another usage, the term “zone” is a shorthand term that may be used to define predetermined roles or responsibilities, or a group of roles and responsibilities, or to an individual, or group of individuals, that are assigned to respond to alerts according to a predetermined set of circumstances (a functional definition). For example, the management staff may be a zone, a group of workers assigned to a portion of a warehouse or production line may be a zone, all members of a fire department may be a separate zone, all members of a city police department, members of a janitorial staff, engineers assigned to assess air quality, and the like. Individuals grouped by their functional contribution may be thought as a “zone” or members of a “zone” according to the present disclosure.

1-27. (canceled)

28. A system, comprising:
one or more smart badges that include a control circuit, a display device, and a location finding circuit configured to interact with a remote location finding system to determine a location of the smart badge;
a management system that includes one or more processors of one or more computers, the management system in communication with the one or more smart badges via one or more communication links between the management system and the smart badges;
wherein the one or more smart badges are configured to provide badge location information to the management system indicating the location of a first badge of the one or more smart badges via the one or more communication links;
wherein the management system is configured to:
receive event location information indicating the location of an event;
use the badge location information and the event location information to determine a distance between the first badge and the event;
send an alert to the first badge when the badge location information of the first badge matches predetermined criteria maintained by the management system; and
wherein the one or more smart badges are configured to display the alert using the display device.

29. The system of claim 28, wherein the management system is configured to use the one or more processors to determine a shortest path between the event and the first badge.

30. The system of claim 28, wherein the management system is configured to determine the shortest path between each of the one or more smart badges and the event.

31. The system of claim 30, wherein the management system is configured to send the alert to a badge of the one or more smart badges with the shortest path between the badge and the event.

32. The system of claim 28, wherein the management system is configured to:
determine a closest badge of the one or more smart badges to the event; and
send an alert to the closest badge.

33. The system of claim 28, wherein the management system is configured to:
determine multiple nearby badges of the one or more badges that are closer to the event than other badges of the one or more badges to the event; and
send an alert to the multiple nearby badges.

34. The system of claim 33, wherein the multiple nearby badges includes at least three badges of the one or more smart badges.

35. The system of claim 28, wherein the management system is configured to determine a zone for each badge of the one or more smart badges.

36. The system of claim 35, wherein the management system is configured to automatically update the zone assigned to each badge of the one or more smart badges when the location of the one or more smart badges changes over time.

37. The system of claim 35, wherein the management system is configured to automatically update the zone assigned to each badge of the one or more smart badges when a user the badge is assigned to changes over time.

38. The system of claim 28, wherein the management system is configured to accept input from a user defining criteria for at least one zone that one or more smart badges may be assigned to.

39. The system of claim 28, wherein the management system is configured to accept input from a user defining multiple zones that one or more smart badges may be assigned to.

40. The system of claim 39, wherein the input defines a hierarchy for the multiple zones defining multiple levels, and wherein at least one zone of the multiple zones is assigned to each of the multiple levels in the hierarchy.

41. The system of claim 39, wherein at least one of the multiple zones is defined according to a predetermined geographical region.

42. The system of claim 39, wherein at least one of the multiple zones is defined to include a fire department or a police department.

43. The system of claim 28, wherein the management system is configured to send the alert to a second badge of the one or more smart badges when no response is received from the first badge within a predetermined response period.

44. The system of claim 43, wherein the second badge is defined by the management system to be in a response zone with the first badge.

45. The system of claim 43, wherein the second badge is defined by the management system to be in a different response zone than the response zone the first badge is in.

46. The system of claim 28, wherein the one or more smart badges include a user interface operable to accept input indicating that a user associated with the a badge of the one or more smart badges is acting on the alert.

47. The system of claim 28, wherein the one or more smart badges include one or more sensors configured to detect one or more sense parameters, the sense parameters including, acceleration, ambient temperature, humidity, heart rate, blood pressure, altitude, movement, orientation with respect to gravity, sound, vibration or any combination thereof.

48. The system of claim 28, wherein the event is generated by a patient monitoring device in communication with the management system, and wherein the patient monitoring device configured to be worn by a patient and is operable to predict when the patient is about to stand up.

49. The system of claim 28, wherein the remote location finding system includes a Global Position System (GPS) system.

50. The system of claim 28, wherein the remote location finding system includes one or more beacons positioned nearby to the smart badge.

51. The system of claim 28, wherein the display device includes an e-ink screen that is optionally touch or pressure sensitive.

52. The system of claim 28, wherein the display device includes a multi-function graphic display that is optionally touch or pressure sensitive.

53. The system of claim 28, wherein the one or more smart badges are configured to:
accept input from a user defining credentials associated with the user;
send the credentials to the management system; and
receive a response from the management system confirming the user's association with the first badge.
